(19) United States
(12) Patent Application Publication
(10) Pub. No.: US 2013/0088656 A1
(43) Pub. Date: Apr. 11, 2013

(54) FREQUENCY CONTROL METHOD OF OPTICAL TUNABLE FILTER DEVICES

(71) Applicants: Sachiko Michihata, Owariasahi-shi (JP); Yuji Hotta, Nagoya-shi (JP)

(72) Inventors: Sachiko Michihata, Owariasahi-shi (JP); Yuji Hotta, Nagoya-shi (JP)

(73) Assignee: SANTEC CORPORATION, Aichi (JP)

(21) Appl. No.: 13/584,066

(22) Filed: Aug. 13, 2012

(30) Foreign Application Priority Data
Oct. 11, 2011 (JP) 2011-223772

(51) Int. Cl. G02F 1/1333; G02F 1/19; G02B 26/00; G02F 1/23

(52) U.S. Cl. 349/33; 359/238; 359/291

(57) ABSTRACT

A method for controlling a characteristic of a variable optical filter including a frequency selecting element includes changing a driving voltage for a specific pixel of the frequency selecting element continuously to produce an amount of change in a frequency that is passed through that pixel, changing a driving voltage value for a specific pixel of the frequency selecting element continuously to produce an attenuation value for a beam that is passed through that pixel, calculating, from a relationship between the driving voltage and a frequency characteristic and between the driving voltage and amount of attenuation, a function that indicates an approximated curve of no less than a second order and no more than a sixth order for expressing a relationship between a transmissivity and a frequency, and controlling the characteristic through driving a controlled pixel of the frequency selecting element based on the function.

### FIELD OF TECHNOLOGY

The present invention relates to a method for controlling properties of an optical variable filter device used in the field of optical communications, the field of spectroscopy, and the like.

Variable optical filters are currently used broadly in fields such as optical communications and spectroscopy. In particular, in the field of optical communications there has been active research and development into increasing transmission rates and into novel modulating formats in order to respond to the demand for transmission capacity in recent years, and optical networks have also become more complex. In such optical networks, variable optical filters having the ability to change optical signals to light of a desired wavelength are used. For example, Patent Document 1 discloses a variable optical filter that uses, as a frequency selecting element, a two-dimensional reflective LCOS (Liquid Crystal On Silicon) liquid crystal element (hereinafter termed a “LCOS element”).

On the other hand, in order to respond to the demand for transmission capacity of recent years, there has been active research and development into increasing transmission rates and into novel modulation formats, and optical networks have become more complex. In such optical networks, the implementation of ROADM (Reconfigurable Optical Add/Drop Multiplexer) devices, which have a reconfigurable add/drop function, is progressing in optical nodes corresponding to branching points in optical network webs. Wavelength selective switches (WSS), for switching any given wavelength in any given direction, are the best hope for achieving a ROADM device. In order for variable optical filters to achieve wavelength selective switching, and to achieve optimal filtering for individual transmission routes and modulating formats for optical communication, there is the need to add, to the conventional frequency (wavelength) selecting function, a function for controlling automatically the central frequency and the pass band of the filter, on the optical frequency level.

### PRIOR ART DOCUMENTS

### Patent Documents

[Patent Document 1] US 2006/0067611A1

### SUMMARY OF THE INVENTION

### Problem Solved by the Present Invention

In a variable optical filter device, there is the need for a function for controlling the central frequency of the filter on the optical frequency level, and a function for making changes to an optical pass band for the transmission rates and modulation formats of the individual optical signals. In order to be able to vary the central frequency and the pass band, one may consider dispersing the light in different directions depending on the frequency of the light, to be incident into a frequency selecting element having a large number of pixels, and turning ON/OFF the transmissivities of the individual pixels.

However, the frequency resolution is limited to the frequencies assigned to the individual pixels, these assigned frequencies are determined by the product (D·d) of the reciprocal linear dispersion rate D, which is the frequency(bandwidth) per unit length on the plane of the frequency selecting elements, and the width d of the elements in the frequency dispersion direction. Because of this, in order to increase the resolution of the frequency selection performance, it is necessary to compress the width of the elements order to reduce the amount of reciprocal-linear dispersion, and thus there is a problem in that this requires the equipment to be larger and requires a frequency selecting element with a larger number of pixels. Given this, it is desirable to be able to increase the frequency resolution without requiring larger equipment or requiring a reduction in size of the frequency selecting elements.

In contemplation of the problem areas with the conventional variable optical filter devices, the technical issue in the present invention is to enable accurate changing of filter characteristics through increasing and making continuous the resolution of the frequency selection without requiring the equipment to be made larger and without requiring the frequency selecting elements to be made smaller.

### Means for Solving the Problem

In order to solve this problem, the method for controlling the properties of the variable optical filter device according to the present invention, is method for controlling a characteristic of a variable optical filter, having a large number of pixels, arranged in a direction of frequency dispersion, for inputting light that has been dispersed spatially depending on frequencies, and having a frequency selecting element having a desired frequency selecting characteristic through changing characteristics of individual pixels, wherein: a driving voltage for a specific pixel of the frequency selecting element is changed continuously to produce an amount of change in a frequency that is passed through that pixel; a driving voltage value for a specific pixel of the frequency selecting element is changed continuously to produce an attenuation value for a beam that is passed through that pixel; a function that indicates an approximated curve of no less than a second order and no more than a sixth order for expressing the relationship between the transmissivity and the frequency is calculated from the relationship between the driving voltage and the frequency characteristic, and between the driving voltage and the amount of attenuation; and the characteristic is controlled through driving a controlled pixel of the frequency selecting element based on that function.

Here the variable optical filter device may comprise: an incident/emitting portion for inputting a beam and emitting a beam of the incident beam with a selected frequency; a frequency dispersing element for dispersing spatially, depending on the frequency thereof, a beam that is incident into the incident/emitting portion and for combining reflected beams; a beam condensing element for condensing, so as to be parallel to a two-dimensional surface, beams that have been dispersed by the frequency dispersing element; a frequency selecting element for producing a desired frequency selecting characteristic through changing a reflectance characteristic of an individual pixels, having a large number of pixels that are arranged in at least the frequency dispersing direction, arranged at locations for receiving beams that are focused by the beam condensing element; and a frequency selecting element driving portion for driving, in gradations, the transmission characteristics for each frequency of the incident beam through driving electrodes of the individual pixels of the frequency selecting element.

Here the variable optical filter device may comprise: an incident portion wherein a beam is incident; a frequency dispersing element for dispersing spatially, depending on the frequency thereof, a beam that is incident into the incident portion and for combining reflected beams; a first beam condensing element for condensing, so as to be parallel on a two-dimensional surface, beams that have been dispersed by the frequency dispersing element; a frequency selecting element for selecting a beam of an arbitrary frequency selecting characteristic through changing a transmissive characteristic of an individual pixels, having a large number of pixels that are arranged in at least the frequency dispersing direction, arranged at locations for receiving beams that are focused by the first beam condensing element; a frequency selecting element driving portion for driving, in gradations, the transmission characteristics for each frequency of the incident beam through driving electrodes of the individual pixels of the frequency selecting element; a second beam condensing element for condensing beams that have passed through the frequency selecting amendment element; a frequency combining element for combining dispersed beams that have been condensed by the second beam condensing element; and an emitting portion for emitting a beam that has been combined by the frequency combining element.

Here the frequency selecting element may be controlled by storing into memory a table indicating the relationship between transmissivities and amounts of frequency variation, which are indicated by the function that has been calculated, and setting, to the frequency selecting element, driving voltages that correspond to the amount of frequency variation of the transmissivity that is required, read out from the table, to control the frequency selecting element.

Here the frequency selecting element may be controlled by storing into memory a table indicating the relationship between transmissivities and amounts of frequency variation, which are indicated by the function that has been calculated, and setting, to the frequency selecting element, driving voltages that are calculated through spline interpolation from the amounts of frequency variation of the transmissivity that are required, read out from the table, to control the frequency selecting element.

Here, in the frequency selecting element, the pixel width in the direction of frequency dispersion may be less than the beam radius, in the direction of frequency dispersion, of the incident beam.

Here the frequency selecting element may be a LCOS element that has a large number of pixels that are arranged in at least one dimension; and the frequency selecting element driving portion may control a voltage applied to an individual pixel in accordance with a frequency selecting characteristic.

Here the frequency selecting element may be a liquid crystal element that has a large number of pixels that are arranged in at least one dimension; and the frequency selecting element driving portion may control a voltage applied to an individual pixel in accordance with a frequency selecting characteristic.

Here the frequency selecting element may be a MEMS element that has a large number of pixels that are arranged in at least one dimension; and the frequency selecting element driving portion may control a voltage applied to an individual pixel in accordance with a frequency selecting characteristic.

Here, for the individual frequencies of the incident beam, a desired continuous pixel group may be placed in a transmissive state, and when an incident/emitted beam ratio wherein there is emission through a pixel group that comprises at least one pixel of the frequency selecting element corresponding to an individual frequency is defined as the transmissivity of that pixel group the band width may be increased through gradually increasing, simultaneously, the transmissivities of at least one first controlled pixel group that is adjacent to a pixel group of an end portion of pixel groups in a transmitted frequency range and of at least one second controlled pixel group that is adjacent to a pixel group at the other end portion of that transmitted frequency band.

Here, for the individual frequencies of the incident beam, a desired continuous pixel group may be placed in a transmissive state, and when an incident/emitted beam ratio wherein there is emission through a pixel group that comprises at least one pixel of the frequency selecting element corresponding to an individual frequency is defined as the transmissivity of that pixel group, the band width may be decreased through gradually decreasing, simultaneously, the transmissivities of at least one first controlled pixel group of an end portion of pixel groups in a transmitted frequency range and of at least one second controlled pixel group of the other end portion of that transmitted frequency band.

Here, for the individual frequencies of the incident beam, a desired continuous pixel group may be placed in a transmissive state, and when an incident/emitted beam ratio wherein there is emission through a pixel group that comprises at least one pixel of the frequency selecting element corresponding to an individual frequency is defined as the transmissivity of that pixel group, a central frequency of a transmission frequency band may be changed along the frequency axis through gradually increasing the optical transmissivity of at least one first controlled pixel group adjacent to a pixel group at an end portion, in the direction of the change of frequency, of the pixel groups of the transmitted frequency band and gradually decreasing the optical transmissivity of at least one second controlled pixel group at the other end portion of the pixel groups of the transmitted frequency band.

### Effects of the Invention

The present invention, having such distinctive features, performs continuous gradation control of the transmissivity of pixels while enabling application to a plurality of pixels arrayed in the direction of dispersion of frequency-dispersed beams. Because of this, it is possible to increase the frequency resolution without requiring the equipment to be made larger and without requiring excessive miniaturization of the frequency selecting elements. This enables the result of being able to change the pass band width with high resolution and accuracy, and to change the central frequency of the pass band accurately.

### BRIEF DESCRIPTION OF THE DRAWINGS

FIG. 1A is a diagram showing the optical configuration, when viewed from the x-axial direction, for one example of a reflective variable optical filter device to which is applied to the characteristic controlling method according to the present invention.

FIG. 1B is a diagram showing the optical configuration, from the y-axial direction, of this reflective variable optical filter device.

FIG. 2A is a diagram showing the optical configuration, when viewed from the x-axial direction, for one example of a transmissive variable optical filter device to which is applied to the characteristic controlling method according to the present invention.

FIG. 2B is a diagram showing the optical configuration, from the y-axial direction, of this transmissive variable optical filter device.

FIG. 3A is a diagram showing a two-dimensional frequency selecting element used in the variable optical filter devices described above.

FIG. 3B is a diagram showing a one-dimensional frequency selecting element used in the variable optical filter devices described above.

FIG. 4A is a diagram illustrating one example of a modulating method for a LCOS element used in a reflective variable optical filter device.

FIG. 4B is a diagram illustrating another example of a modulating method for a LCOS element used in a reflective variable optical filter device.

FIG. 5 is a diagram showing one pixel of an MEMS element used in a reflective variable optical filter device

FIG. 6A is a diagram illustrating one example of a modulating method for a LCOS element used in a transmissive variable optical filter device.

FIG. 6B is a diagram illustrating another example of a modulating method for a LCOS element used in a transmissive variable optical filter device.

FIG. 7A is a diagram illustrating a method for control when the band width of the band pass filter in the first form of embodiment according to the present invention is to be increased.

FIG. 7B is a diagram illustrating a method for control when the band width of the band pass filter in the first form of embodiment according to the present invention is to be decreased.

FIG. 8 is a diagram illustrating an example of changing the band width of the variable optical filter device in first and second forms of embodiment according to the present invention.

FIG. 9A is a graph showing the changes in frequency when changing continuously the controlled pixel group in a method for controlling characteristics of a variable optical filter according to a form of embodiment according to the present invention.

FIG. 9B is a graph showing the changes in the attenuation levels when changing the voltage continuously.

FIG. 9C is a graph showing the attenuation level relative to the amount of change in the frequency in this form of embodiment.

FIG. 9D is a graph showing changes in the transmissivity relative to the amount of change in frequency.

FIG. 9E is a graph showing the transmissivity relative to the amount of change in frequency through an approximation curve.

FIG. 10 is a block diagram illustrating a configuring system for determining the pixel locations and characteristics for a frequency dispersing element.

FIG. 11 is a flowchart showing the process for determining the frequency relative to the x coordinate in the present example of embodiment.

FIG. 12 is a diagram showing the LCOS element, showing the state wherein lines of pixels are in the reflective state.

FIG. 13A is a spectrograph showing a frequency scanning beam of a variable frequency light source 61.

FIG. 13B is a diagram illustrating the change in the optical power obtained through an optical power meter.

FIG. 13C is a diagram illustrating the change in power in the time domain, obtained from an optical power meter.

FIG. 14 is a graph showing the frequency per pixel group relative to the individual pixel numbers.

FIG. 15A is a diagram illustrating the method of control when increasing the central frequency of the band pass filter in the second form of embodiment according to the present invention.

FIG. 15B is a diagram illustrating the method of control when decreasing the central frequency of the band pass filter in the second form of embodiment according to the present invention.

FIG. 16A is a diagram illustrating an example of increasing the central frequency of a variable optical filter device according to the first or second form of embodiment according to the present invention.

FIG. 16B is a diagram illustrating an example of decreasing the central frequency of a variable optical filter device according to the first or second form of embodiment according to the present invention.

FIG. 17 is a diagram illustrating an example of increasing the central frequency of a variable optical filter device according to the first or second form of embodiment according to the present invention.

FIG. 18 is a graph showing the state wherein the band width is not changed. FIG. 19A is a graph showing the relationship between the change in the central frequency and the transmissivity when there has been a change in the transmissivity of a controlled pixel group in the case of γ=2.7.

FIG. 19B is a graph showing the relationship between the change in the central frequency and the transmissivity when there has been a change in the transmissivity of a controlled pixel group in the case of γ=1.8.

FIG. 19C is a graph showing the relationship between the change in the central frequency and the transmissivity when there has been a change in the transmissivity of a controlled pixel group in the case of γ=1.2.

FIG. 19D is a graph showing the relationship between the change in the central frequency and the transmissivity when there has been a change in the transmissivity of a controlled pixel group in the case of γ=1.0.

FIG. 19E is a graph showing the relationship between the change in the central frequency and the transmissivity when there has been a change in the transmissivity of a controlled pixel group in the case of γ=0.5.

FIG. 19F is a graph showing the relationship between the change in the central frequency and the transmissivity when there has been a change in the transmissivity of a controlled pixel group in the case of γ=0.25.

### FORMS FOR CARRYING OUT THE INVENTION

(A Reflective Variable Optical Filter Device)

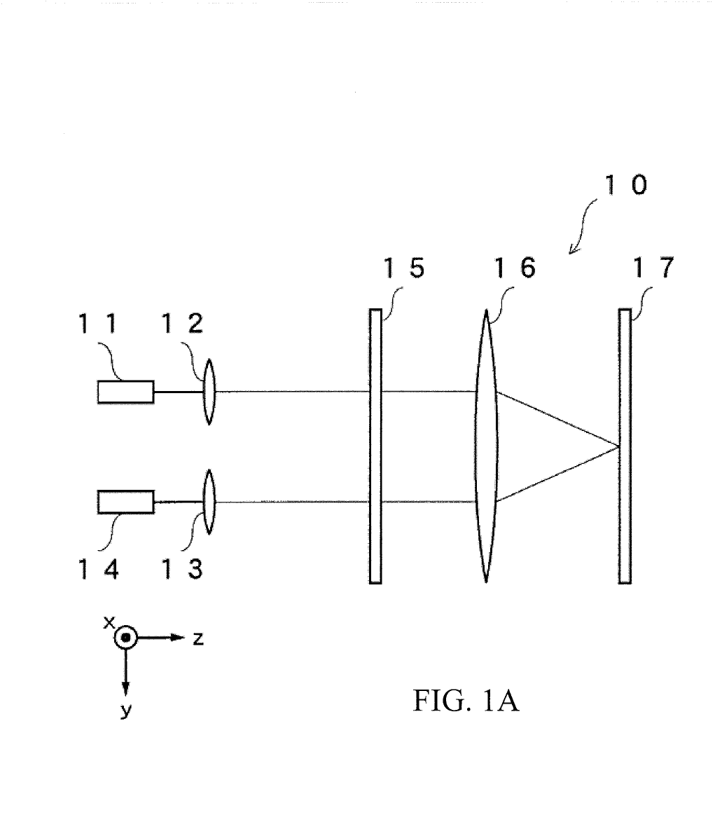

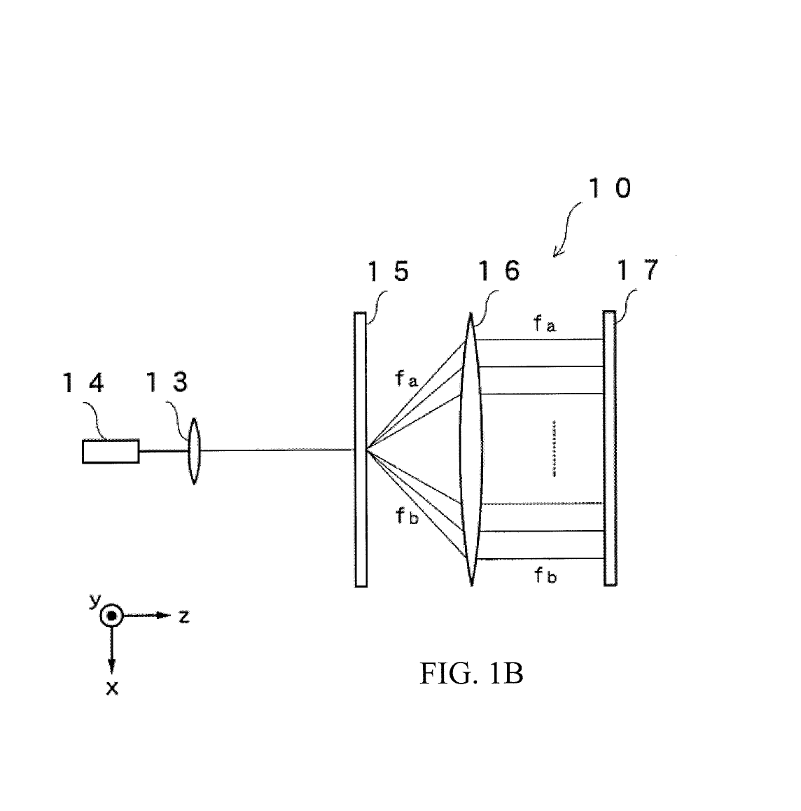

FIG. 1A is a side view diagram, when viewed from the x-axial direction, showing the structure of an optical element for a reflective variable optical filter device 10A that is subject to the characteristic control of the present invention, and FIG. 1B is a side view diagram thereof when viewed from the y-axial direction. The incident beam is a WDM signal beam wherein, for example, optical signals of frequencies fₐ through f_{b} are superimposed thereon. The WDM beam is emitted through an optical fiber 11 from a collimating lens 12. Moreover, a beam that is incident on into a collimating lens 13 is emitted to the outside through an optical fiber 14. The beam that is emitted from the collimating lens 12 is parallel to the z axial direction, and is incident into a frequency dispersing element 15. In the frequency dispersing element 15, the beam is dispersed in different directions, in the x-z plane, depending on the frequency thereof. Here the frequency dispersing element 15 may be a diffraction grating, or may use a prism, or the like. It may also be structured from a combination of a diffraction grating and a prism. The beam that is dispersed by the frequency dispersing element 15 is applied to a lens 16 that is a beam condensing element. The lens 16 is a beam condensing element that condenses the beams that have been dispersed in the x-z plane, into a beam that is parallel to the z-axial direction, so that the condensed beam is caused to be incident, in the perpendicular direction, onto a frequency selecting element 17.

Here FIG. 1B shows an example of a beam wherein the minimum frequency is fₐ and the maximum frequency is f_{b}, but because the incident beam is a WDM signal beam having a large number of spectra between the frequencies fₐ and f_{b}, the WDM signal beam that is deployed across the x-z plane is applied to a band-shaped frequency selecting element 17. The incident beam is reflected selectively by the frequency selecting element 17, and the selective characteristic of the optical filter is determined by the reflective characteristics thereof, and the details of which are described below. The beams that are reflected by the frequency selecting element 17 are applied to the lens 16 through a common path, and then are applied again to the frequency dispersing element 15. The frequency dispersing element 15 combines the reflected beams to condense into a beam in the same direction as the original incident beam, where this condensed beam passes through the collimating lens 13 to be emitted through the optical fiber 14. The optical fibers 11 and 14, and collimating lenses 12 and 13, structure an incident/emitting portion wherein a beam is incident and a selected beam is emitted.

While the optical axes of the incident beam and the emitted beam in the present form of embodiment are separate, instead these optical axes may be shared, where the incident and emitted beams may be carried by the same fiber, or the incident and emitted beams may be separated by a circulator to be carried on individual optical fibers 11 and 14.

(Transmissive Variable Optical Filter Device)

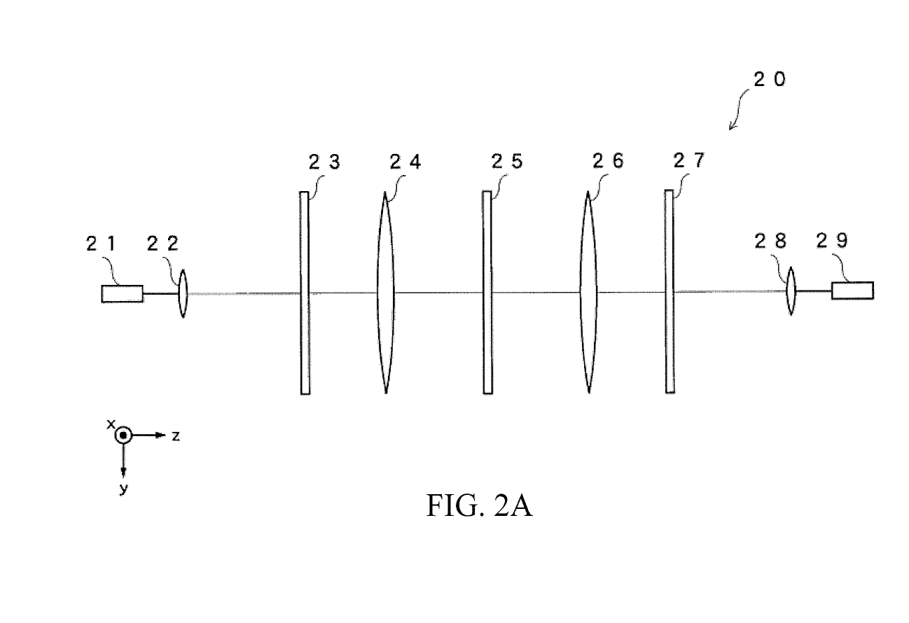

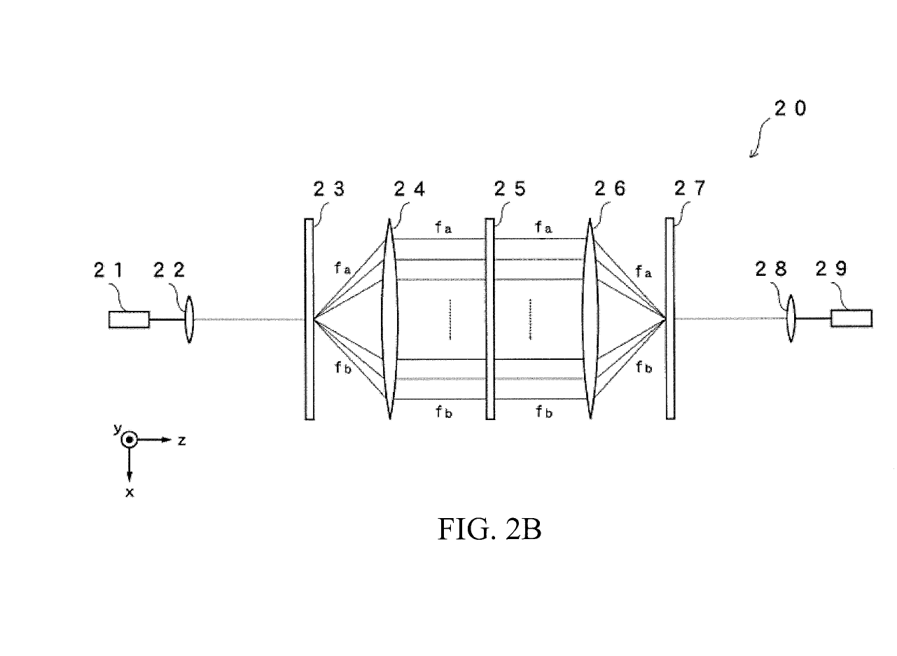

A transmissive variable optical filter device that is subject to the characteristic control by the present invention will be explained next. FIG. 2A is a side view diagram, when viewed from the x-axial direction, showing the structure of an optical element for this transmissive variable optical filter device 20, and FIG. 1B is a side view diagram thereof when viewed from the y-axial direction. In FIG. 2A, the incident beam is the WDM signal that was explained in the first example of embodiment, and is incident from the optical fiber 21 into the collimating lens 22, to be applied as a parallel light beam onto a first frequency dispersing element 23. The optical fiber 21 and the collimating lens 22 structure an incident portion wherein the WDM signal beam is incident. As with the frequency dispersing element 15, the frequency dispersing element 23 can be achieved through a diffraction grating, a prism, or a combination of a diffraction grating with a prism. The frequency dispersing element 23, as illustrated in FIG. 2B, emits beams in a different directions, in the x-z plane, depending on the frequencies of the beams. The beam, regardless of which, is incident into the lens 24. The lens 24 is a first condensing element for condensing the beam that was dispersed in the x-z plane so as to be parallel with the z axis. Moreover, a frequency selecting element 25 is disposed perpendicularly to the optical axis of the lens 24. The frequency selecting element 25 is one that allows partial transmission of the incident beam, and the details thereof are described below. The beam that has passed through the frequency selecting element 25 is incident into the lens 26. The lens 24 and the frequency dispersing element 23 are a mirror image, on the x-y plane in the center of the frequency selecting element 25, with the lens 26 and a frequency combining element 27. The lens 26 is a second beam condensing element for condensing into parallel beams on the x-z plane, where the frequency combining element 27 combines and emits a beam of frequency components from different directions. The beam that has been combined by the frequency combining element 27 is applied through a collimating lens 28 into an optical fiber 29. The collimating lens 28 and the optical fiber 29 structure an emitting portion for emitting a beam of a selected frequency.

(Structure of the Frequency Selecting Element)

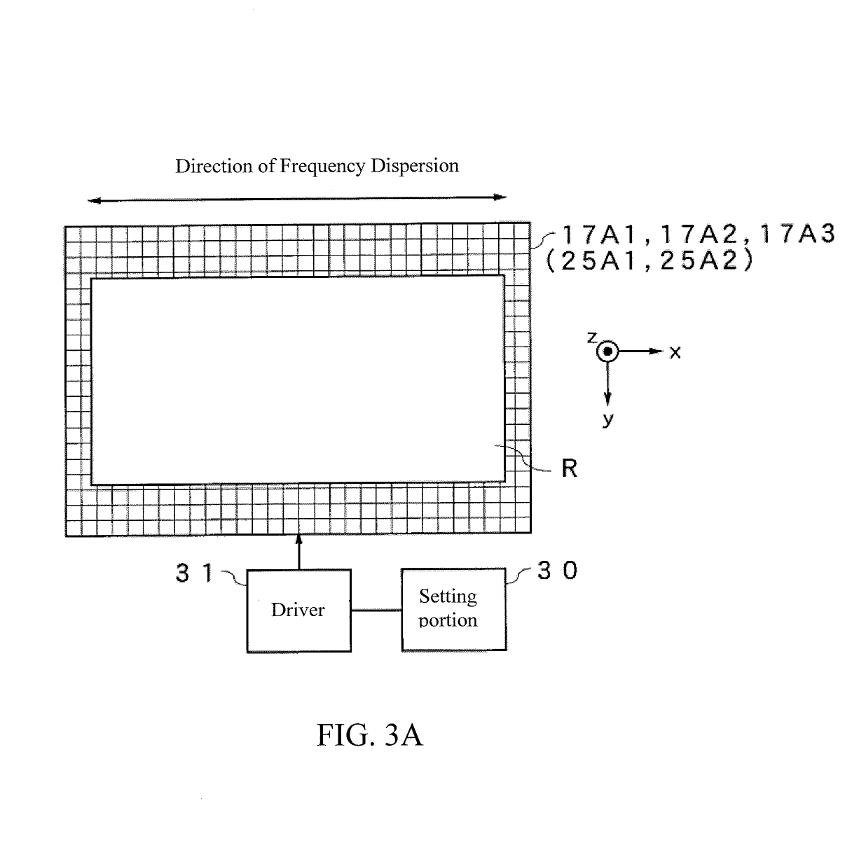

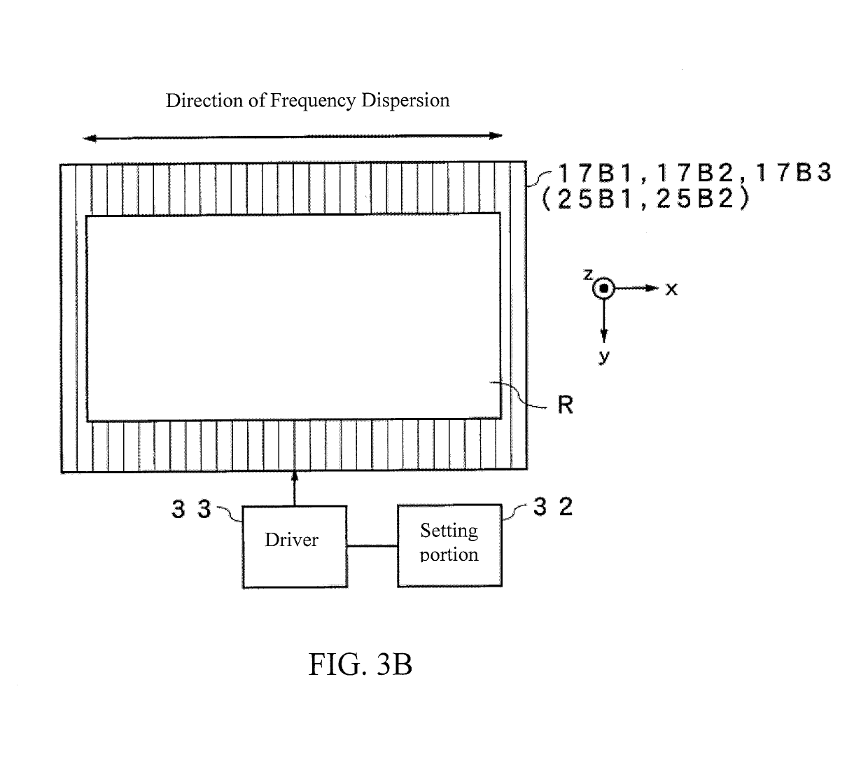

The frequency selecting element 17 and 25 that are used in these variable optical filter devices will be explained next. When the incident beam that is dispersed in the x-z plane depending on the frequency thereof, to form a band-shaped light, is incident on the frequency selecting elements 17 and 25, the incident region is a rectangular region R that is shown in FIG. 3A. In the variable optical filter device 10, the pixels that are caused to be reflective are selected to enable the selection of beams of any given frequency. In the variable optical filter device 20, the beams of any given frequencies can be selected through selecting the pixels that are caused to be transmissive. A setting portion 30 is connected through a driver 31 to the frequency selecting elements 17 and 25. The setting portion 30 selects the pixels for reflecting or transmitting the light in the x-y plane by matching them to the selected frequencies. The driver 31 includes a D/A converting device for converting inputted digital signals into voltages to be applied to the pixels. The setting portion 30 and the driver 31 structure a frequency selecting element driving portion for driving the electrodes of the individual pixels that are arrayed in the x-y directions of the frequency selecting element so as to control the characteristics of the pixels that are disposed in specific locations in the x and y axial directions.

A specific example of a frequency selecting element 17 will be explained next. The first example of the frequency selecting element 17 will be a two-dimensional reflective LCOS (Liquid Crystal On Silicon) liquid crystal element (hereinafter termed “LCOS element”) 17A1. The two-dimensional LCOS element 17A1 has an on-board liquid crystal modulating driver on the back face of each individual pixel, enabling there to be a large number of pixels, enabling the structuring of pixels in, for example, a 1000×1000 pixel array. Because in the LCOS element 17A1 the light beams are incident at a different location for each individual frequency, it is possible to set into a reflective state a pixel of a specific location in order to select the beam of that frequency.

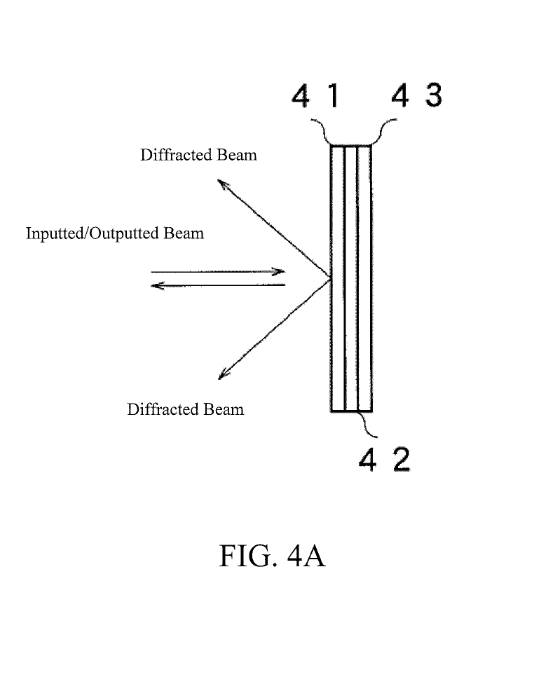

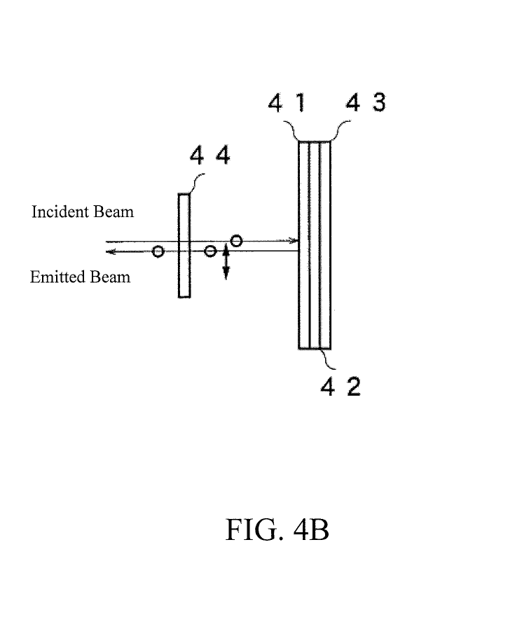

A phase modulating method, which is one method of modulation in the LCOS element 17A1, will be explained here. FIG. 4A is a schematic diagram illustrating the LCOS element 17A1, structured from a transparent electrode 41, a liquid crystal 42, and a back plane reflective electrode 43 that are layered along the z axis, sequentially, from the face wherein the light is incident. The LCOS element 17A1, as illustrated in FIG. 3, is able to produce a diffraction phenomenon through the creation of a pattern in the index of refraction through the application of voltages between the transparent electrodes 41 and the back plane reflective electrodes 43 for the plurality of pixels in order to cause a plurality of pixels to correspond in the y-axial direction with the location corresponding to an individual wavelength. Moreover, the diffraction angle for each individual frequency component can be controlled independently, to diffract so that the beam that is inputted at a specific frequency will be reflected to as-is in the incident direction, where the other frequency components will be diffracted as extraneous light, to enable reflection of that light in directions other than the incident direction. Given this, through analog control of the voltages that are applied to the individual pixels it is possible to control the reflectivities continuously in graduated of control in a range from the required pixel being in a reflective state to being in a non-reflective state. Moreover, if a given pixel in the x-axial direction is in the reflective state, then it will be possible to select a beam of any given frequency of the incident beam. Given this, the control of the reflectivity for the individual frequency components is not ON/OFF control, but rather is continuous analog control.

An intensity modulating method, which is another modulating method for the LCOS element 17A1, will be explained next. FIG. 4B is a diagram illustrating the frequency selecting method using the intensity modulating method, where polarizing elements 44 are arranged on the surface wherein the incident beam is incident. The polarizing elements 44 place the incident beam into the specific polarized state indicated by the 0 in the figure, and cause the incident beam to be incident into the reflective LCOS element 17A1. In this case, the LCOS element 17A1 is structured from a transparent electrode 41, a liquid crystal 42, and a back plane reflective electrode 43. When a beam is incident into the LCOS element 17A1, the difference in birefringence of the liquid crystal between the electrodes can be controlled through the state of application of a voltage. In the intensity modulating method, identical voltages are applied simultaneously to the pixels that are lined up in the y-axial direction in FIG. 3A, making it possible to cause differences in the states of polarization of the reflected light through controlling the states of polarization of the pixels to which the voltages are applied. Here whether the plane of polarization is rotated or is maintained when the voltage is controlled is determined by the orientation component of the liquid crystal molecules. For example, if the plane of polarization is maintained when no voltage is applied, then the light that is shown in the state indicated by the circles in the figure will be reflected as-is. On the other hand, if the plane of polarization is rotated through the application of a voltage, and then reflected, then, because of this, the reflected light would be blocked by the polarizing element 44. Consequently, it is possible to produce continuous graduated control of the reflectivity, between a state wherein the incident light is reflected and a state wherein it is not reflected, through analog control of the voltage that is applied to the pixel. Moreover, it is possible to select light of any given frequency of the incident light through placing into a reflective state any given pixel in the x axial direction. In this case, the reflectivities for the various frequency components are defined as being under analog control.

Moreover, a reflective two-dimensional electrode array liquid crystal element 17A2 that is not of a LCOS structure will be explained as a second example of this frequency selecting element 17. While the LCOS element has built-in liquid crystal drivers on the back faces of the pixels, the two-dimensional electrode array liquid crystal element 17A2 is provided with driver elements, on the outside, for liquid crystal modulation. The other structures are identical to those of the LCOS element, and are able to achieve the aforementioned phase modulating method and intensity modulating method. Moreover, for the pixels, continuous graduated control of the reflectivities is possible through analog changes to the voltage levels.

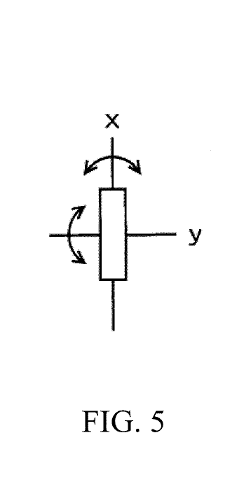

A two-dimensional MEMS element 17A3 will be explained as a third example of a frequency selecting element 17. An MEMS element, wherein a plurality of MEMS mirrors are arranged in two dimensions, is achieved as a Digital Micro Device (DMD). All of the pixels in one row of MEMS mirrors, in the y-axial direction, correspond to a given optical frequency of the WDM signal. When MEMS is used, then a plurality of the MEMS element pixels corresponds to one frequency band, and thus it is possible to vary the reflectivity through phase modulation through controlling the voltages that are applied to the plurality of pixels that corresponds to a single frequency. As is illustrated in FIG. 5, it is possible to perform intensity modulation through rotating the individual pixels of the MEMS element around the x axis and the y axis, to control the mirror angle by the voltage level that is applied to each pixel, to enable setting of the reflectivity to any given intensity. Consequently, in this case it is possible to perform graduated control of the intensity level of the light of the selected frequency band.

A one-dimensional LCOS element 17B1 will be explained next as a fourth example of a frequency selecting element 17. An LCOS element wherein a large number of long and thin pixel elements are arranged in the x-axial direction, as illustrated in FIG. 3B, is used as the frequency selecting element 17B1, and a WDM beam that is dispersed along the x axis depending on the frequency is incident. In this case as well, the structure is one wherein a frequency selecting element driving portion for driving the characteristics of a pixel at a specific location in the x-axial direction through driving the electrodes of the individual pixels that are arranged in the x-axial direction of the frequency selecting element 17 is structured from a setting portion 32 and a driver 33. The LCOS element 17B1 is driven by the setting portion 32 through the driver 33. In this case, the frequency is selected by the intensity modulating method alone, without using the phase modulating method that is described above.

As a fifth example of a frequency selecting element 17, a reflective liquid crystal element 17B2 that has a one-dimensional electrode array can be used. In this case, the frequency selection is through the intensity modulating method only, without using the phase modulating method.

Moreover, as a sixth example of a frequency selecting element 17, a reflective one-dimensional MEMS mirror element 17B3 can be used. In this case, the frequency selection is through the intensity modulating method only, without using the intensity phase modulating method.

A transmissive frequency selecting element 25 that is used for an adjustable wavelength filter device in a second form of embodiment will be described next. A structure wherein a transmissive two-dimensional LCOS elements 25A1 is used may be used as a first example of this frequency selecting element 25. In the LCOS elements 25A1 as well, a light beam is incident on a different location for each individual frequency, making it possible to select the optical signals through the transmissive states of the pixels at those positions.

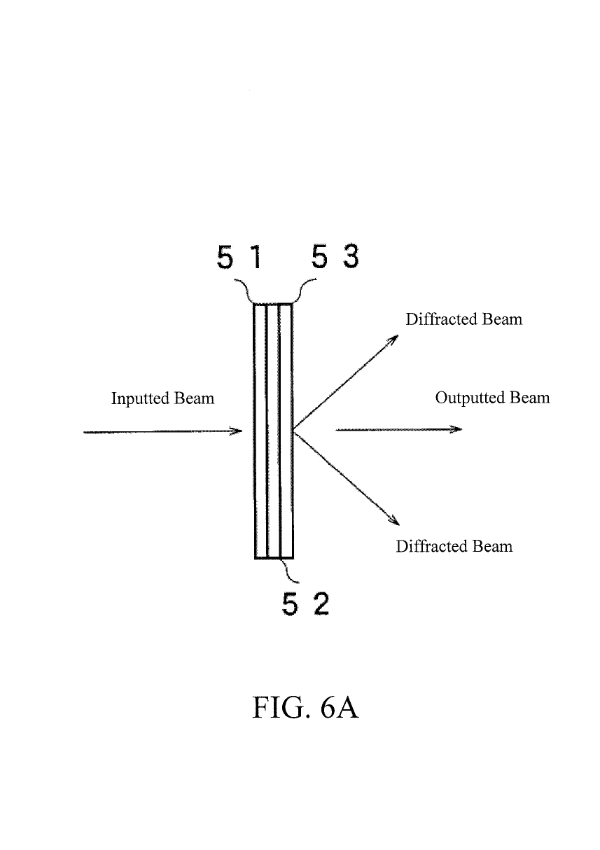

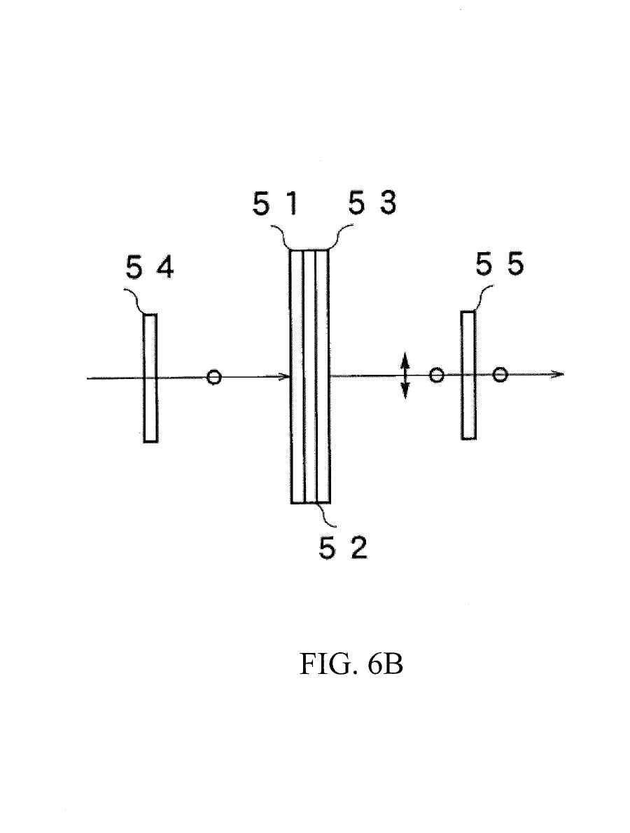

A phase modulating method, which is one method of modulation in the LCOS element 25A1, will be explained here. FIG. 6A is a schematic diagram illustrating the LCOS element, structured from a transparent electrode 51, a liquid crystal 52, and a transparent electrode 53 that are layered along the z axis, sequentially, from the face wherein the light is incident. The LCOS element 25A1 is able to produce a diffraction phenomenon through the creation of a pattern in the index of refraction through the application of voltages between the transparent electrodes 51 and the transparent electrodes 53 for the plurality of pixels in order to cause a plurality of pixels to correspond in the y-axial direction with the location corresponding to an individual wavelength. Moreover, the diffraction angle for each frequency component can be controlled independently, to cause a beam that is inputted at a specific frequency to progress directly as-is in the z-axial direction, where the other frequency components will be diffracted as extraneous light, to enable diffraction of that light in directions other than the z-axial direction. Because of this, through control of the voltages that are applied to the individual pixels it is possible to cause the required pixels to be in a transmissive state, rather than being diffractive. Given this, the control of the transmissivity for the individual frequency components is not ON/OFF control here either, but rather is continuous analog control.

An intensity modulating method, which is another modulating method for the LCOS element, will be explained next. FIG. 6B is a diagram illustrating the wavelength selecting method using the intensity modulating method, where polarizing elements 54 are arranged on the surface wherein the incident beam is incident. The polarizing elements 54 place the incident beam into the specific polarized state indicated by the 0 in the figure, and cause the incident beam to be incident into the LCOS element 25A1. In this case, the LCOS element is structured from a transparent electrode 51, a liquid crystal 52, and a transparent electrode 53. Polarizing elements 55 are disposed on the optical axes of the emitted beams that have passed through the LCOS elements. The polarizing elements 55 cause the emission of only the incident beams of the specific polarized state indicated by the 0 in the figure. When a beam is incident into the LCOS element, the difference in birefringence of the liquid crystal between the electrodes can be controlled through the state of application of a voltage. Consequently, the states of polarization of the transmitted light can be varied through controlling independently the states of polarization of the voltage that is applied. Here whether the plane of polarization is rotated or is maintained when the voltage is controlled is determined by the orientation component of the liquid crystal molecules. For example, if the plane of polarization is maintained when no voltage is applied, then the light that is shown in the state indicated by the circles in the figure will be transmitted as-is. On the other hand, if the plane of polarization is rotated through the application of a voltage, and then transmitted, then, because of this, the transmitted light would be blocked by the polarizing element 55. Consequently, it is possible to select an incident beam through controlling the voltages that are applied to the pixels. If here a given pixel is in the transmissive state, then it is possible to select a beam of the frequency corresponding to the pixel. In this case, the control of the transmissivities for the various frequency components are under continuous analog control.

Moreover, a transmissive two-dimensional electrode array liquid crystal element 25A2 that is not of a LCOS structure can be used as a second example of this frequency selecting element 25. While the LCOS element has built-in liquid crystal drivers on the back faces of the pixels, the two-dimensional electrode array liquid crystal element 25A2 is provided with driver elements, on the outside, for liquid crystal modulation. The other structures are identical to those of the LCOS element, and are able to achieve the aforementioned phase modulating method and intensity modulating method. Moreover, for the pixels, continuous graduated control of the transmissivities is possible through analog changes to the voltage levels.

A one-dimensional LCOS element 25B1 will be explained next as a third example of a frequency selecting element 25. A transmissive LCOS element wherein a large number of long and thin pixel elements are arranged in the x-axial direction, as illustrated in FIG. 3B, is used as the frequency selecting element 25B1, and a WDM beam that is dispersed along the x axis depending on the frequency is incident. In this case as well, the structure is one wherein a frequency selecting element driving portion for driving the characteristics of a pixel at a specific location in the x-axial direction through driving the electrodes of the individual pixels that are arranged in the x-axial direction of the frequency selecting element 17 is structured from a setting portion 32 and a driver 33, and the LCOS elements 25B1 is driven by the setting portion 32 through a driver 33. In this case, the frequency is selected by the intensity modulating method alone, without using the phase modulating method that is described above.

As a fourth example of a frequency selecting element 25, an electrode array liquid crystal element 25B2 that has a transmissive one-dimensional electrode array can be used. In this case, the frequency selection is through the intensity modulating method only, without using the phase modulating method.

(Changing the Band Width)

The details of the frequency control of the variable optical filter device according to the first form of embodiment according to the present invention will be explained next. Note that even though in the explanation below this is a reflective variable optical filter device, the portion of the incident light that is reflected by an individual pixel of the frequency selecting element is returned to the output side, and thus the explanation considers this to be the “transmissivity.” Even though a two-dimensional frequency selecting element is used in the explanation below, the pixels that all correspond to the same frequency, that is, all of the pixels along the entire y axis that all share the same x coordinate, are considered to be a single pixel group. That is, in the explanation, the frequency selecting element has pixel groups P1 through Pm laid out in the x-axial direction. Note that for a one-dimensional frequency selecting element, a single pixel would correspond to one of these “pixel groups.” The pixel groups P₁ through Pₘ each has its own reflectivity and T₁ through Tₘ.

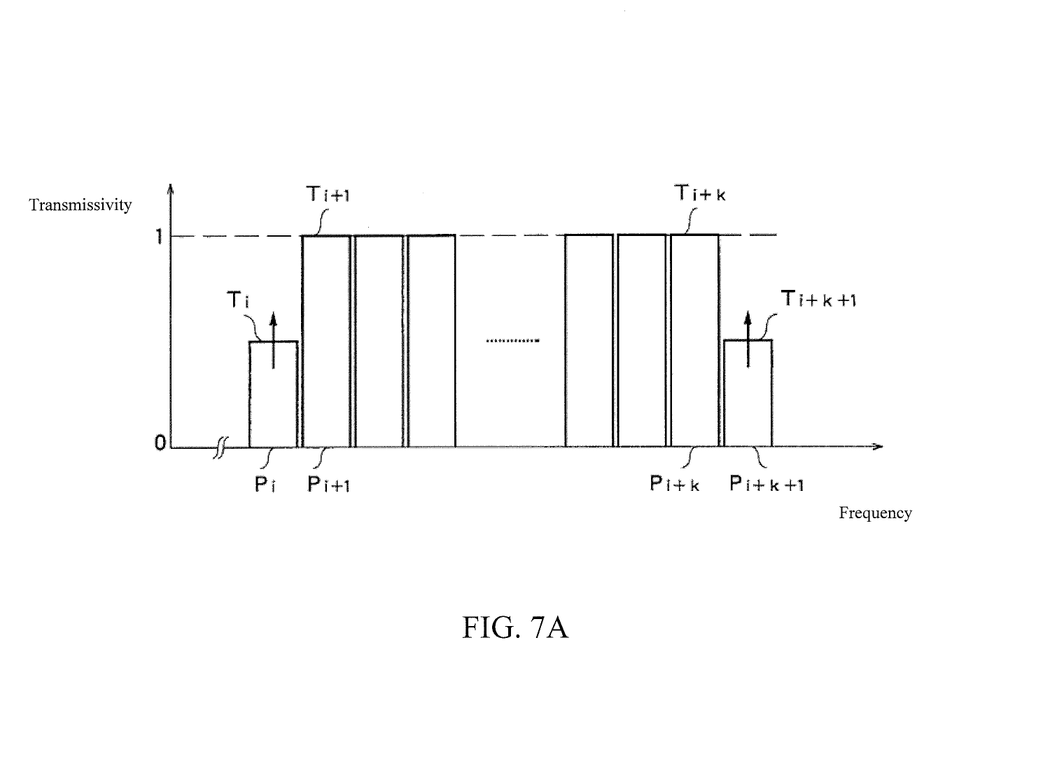

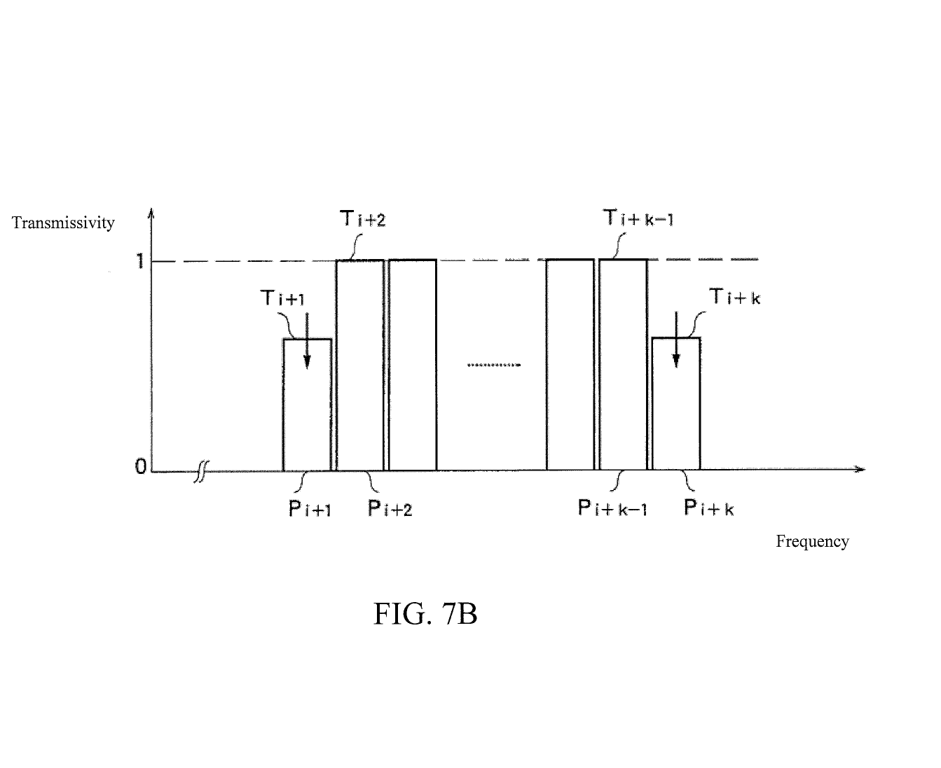

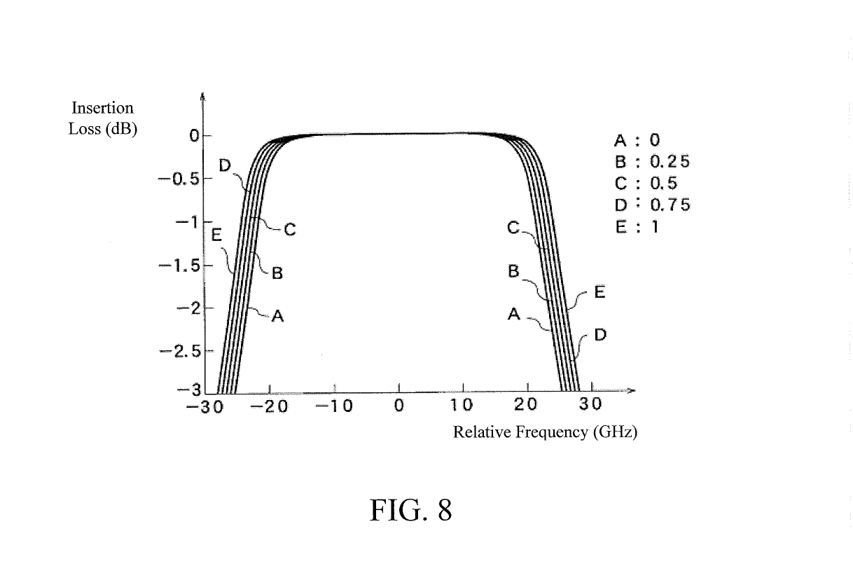

FIG. 7A and FIG. 7B are graphs wherein the horizontal axes are frequencies and the vertical axes are the transmissivities of the pixel groups of the frequency selecting element. In the initial state, the transmissivities Tᵢ₊₁ through Tᵢ₊ₖ of the pixel groups Pᵢ₊₁ through Pᵢ₊ₖ (where 1≦i and k≦m) are 1, and the transmissivities of the other pixel groups are 0. Doing so produces a band pass filter wherein a single frequency band wherein the transmissivity is 1 is transmissive. If the bandwidth is to be increased, then the transmissivities of the pixel groups adjacent to both ends are simultaneously and continuously increased. Here the pixel groups for which the transmissivity is changed are referred to as controlled pixel groups, where P, and Pᵢ₊ₖ₊₁ are termed, respectively, first and second controlled pixel groups. As shown in the graph in FIG. 7, the transmissivities Tᵢ and Tᵢ₊ₖ₊₁ of the controlled pixel groups Pᵢ and Pᵢ₊ₖ₊₁ are changed continuously in an analog change. For example, if the transmissivities of the controlled pixel groups Pᵢ and Pᵢ₊ₖ₊₁ are increased simultaneously and continuously from 0 to 1, then, as shown in FIG. 8, the band width thereof can also be increased concomitantly. In FIG. 8, the curves A through E show the increases from 0 to 1 in the transmissivities Tᵢ and Tᵢ₊ₖ₊₁ simultaneously in units of 0.25. Note that FIG. 8 is an example of a case wherein the conditions set forth below are fulfilled in an optical filter that is used for a WDM signal with a 50 GHz channel bandwidth:
(1) The amount of linear dispersion in the plane of the frequency selecting element, that is, the width on the pixels per 1 GHz is 2.89 μm/GHz;
(2) The radius w of the optical beam is 22.6 μm;
(3) The pixel width on the frequency selecting element in the direction of the frequency dispersion is 8.5 μm; and
(4) There is one controlled pixel group on both the high-frequency side and the low-frequency site.

In this example, the transmissive characteristic, as indicated by the curves A and E, in the present example are changed from a bandwidth of ±25 GHz from the central frequency to one of ±28 GHz. In this case, it corresponds to a band of 1.5 GHz for the controlled element group Pᵢ and group Pᵢ₊ₖ₊₁. Increasing continuously the transmissivity of the controlled pixel groups on both ends in this way enables a continuous increase in width of the bandwidth.

Next, as shown in FIG. 7B, from the initial state, set forth above, of the pixel groups Pᵢ₊₁ through Pᵢ₊ₖ that structure the band pass filter, the transmissivities Tᵢ₊₁ and Tᵢ₊ₖ of the pixel groups Pᵢ₊₁ and Pᵢ₊ₖ (the first and second controlled pixel groups) that is the pair on both ends, is gradually decreased from 1 to 0, enabling a reduction in the band width of the band pass filter.

It is possible, in this way, to increase or decrease the bandwidth of a band pass filter by changing, continuously and in the same direction, the transmissivities of a pair of pixel groups on the high-frequency side and the low-frequency side of a specific band width. Although the number of controlled pixel groups on the two sides was one each, there is no limitation thereto, but rather it is possible to change the filter slope characteristics of the band pass filter by controlling a plurality of pixel groups simultaneously. Moreover, if the width over which a pass band can be varied is more than a frequency band corresponding to two pixel groups, then it is possible to control, limitlessly and continuously, the width over which a pass band can be varied by shifting the controlled pixel groups sequentially to the adjacent pixels.

Given this, the transmissivity does not change linearly with changes of the voltage that is applied to each group of controlled pixels, but rather changes non-linearly. Consequently, it is possible to control the selected frequency accurately through establishing this relationship in advance in order to change the transmissivity accurately. Note that in the below the transmissivities of the individual pixels are controlled through an intensity modulating method wherein the amount of attenuation is changed through the voltage.

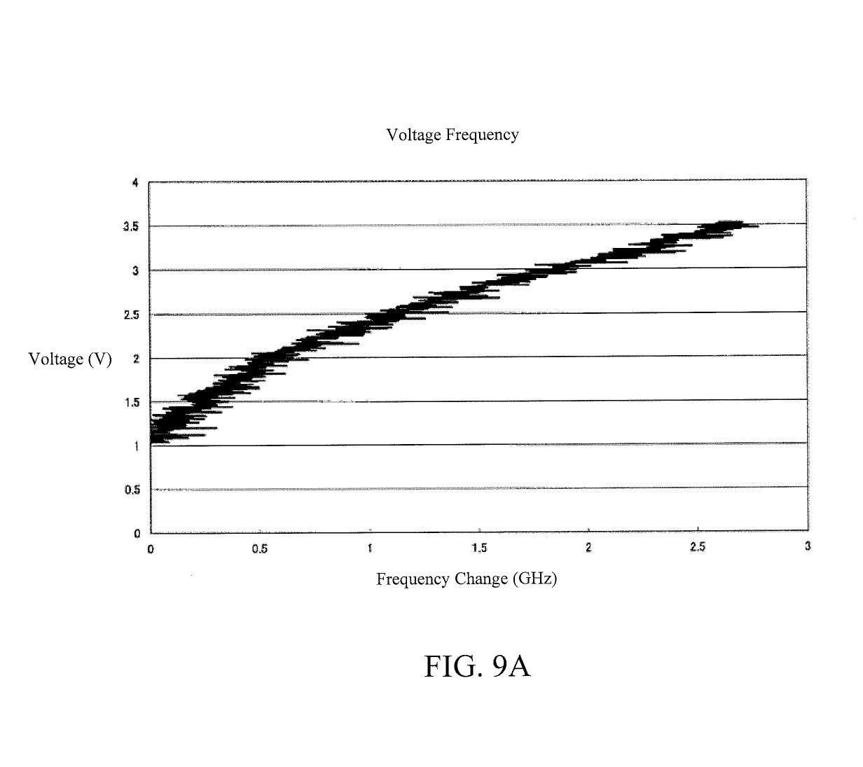

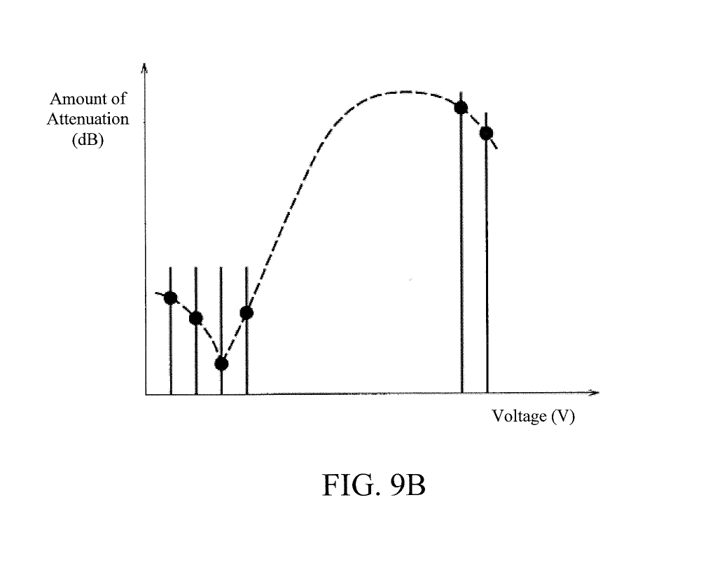

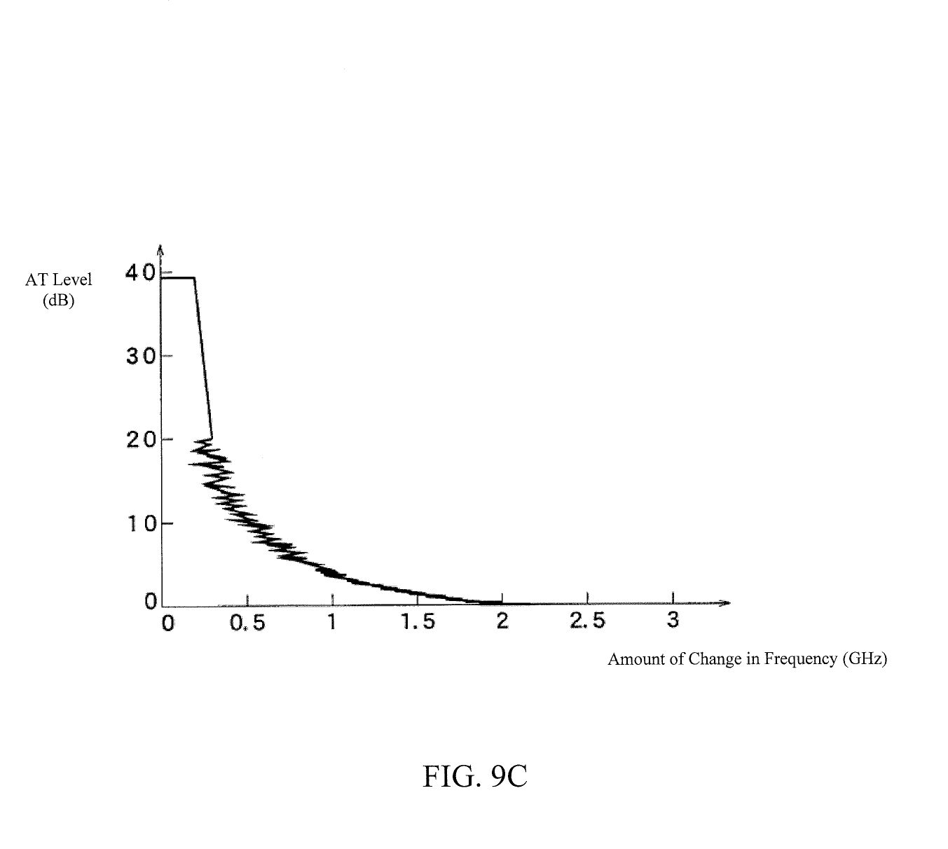

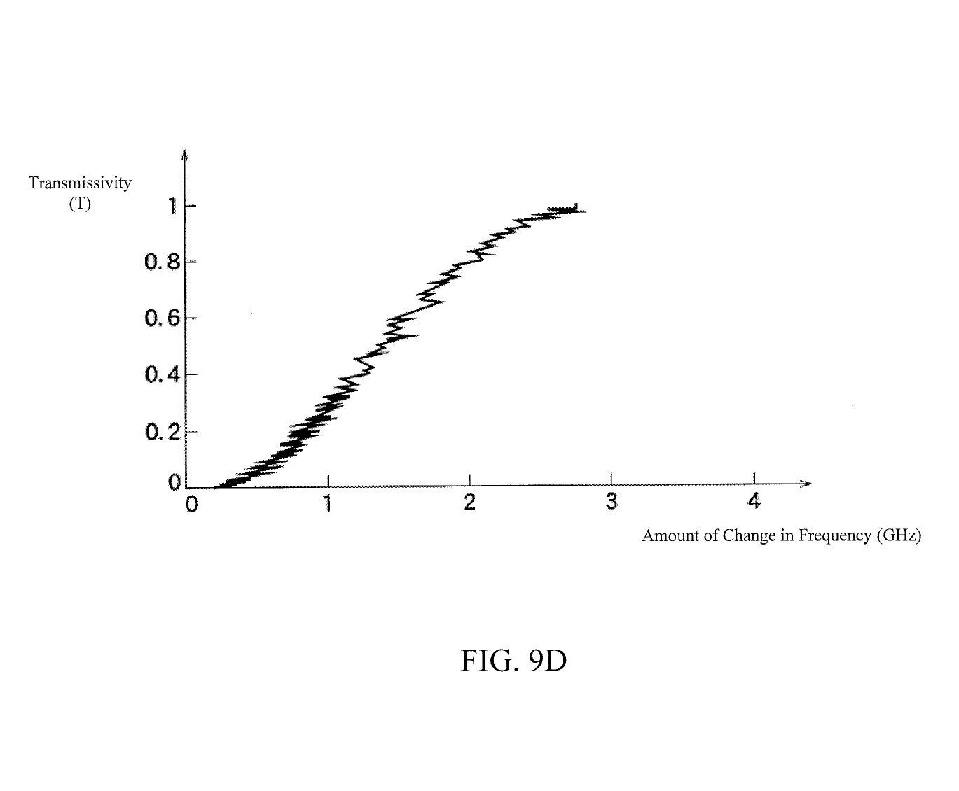

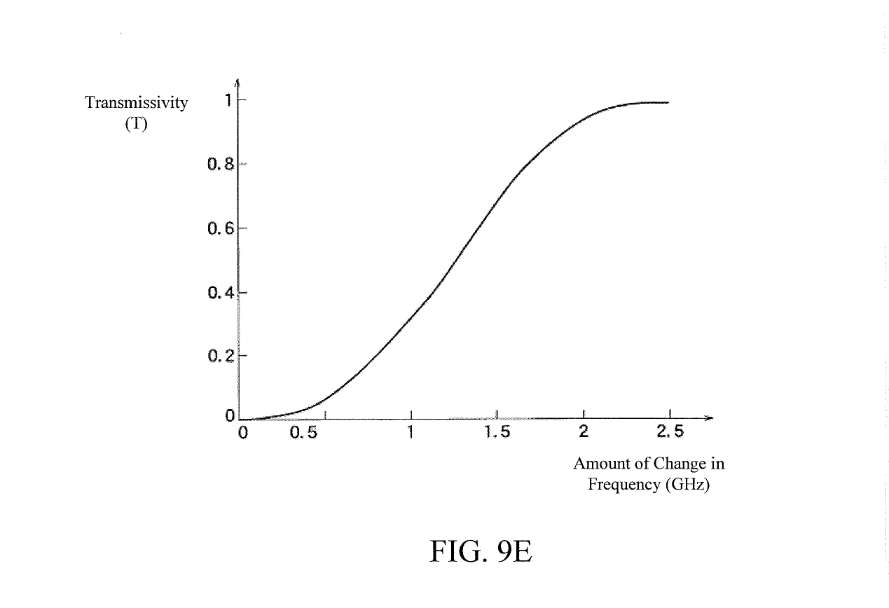

Given this, a method whereby the per-pixel transmissivity and the amount of change in the frequency can be obtained as data will be explained below. First a specific pixel group of the frequency selecting element is selected as a controlled pixel group, and the value of the voltage that is applied to the controlled pixel group is varied continuously from 0 to a maximum value. Given this, data for the actual amount of change in the frequency obtained through the change in the value of the voltage is acquired. FIG. 9A is a graph showing the change in frequency when the voltage for when the frequency width corresponding to the controlled pixel group was 2.5 GHz was changed continuously, and while there is variability in the data, it is possible to envision an approximation curve on a curved line. While FIG. 9A shows one example of data obtained in this way, data may be obtained from several different pixel groups and an averaging process may be performed.

Data is then taken for the voltage and power levels for the pixel group. That is, data is measured for the attenuation level AT that is obtained for transmission through the pixel when the voltage is changed continuously. FIG. 9B is an example of this graph, showing the attenuation level in decibel values.

Given this, an attenuation level is calculated for the frequencies by converting the horizontal axis to frequencies from the relationships between the voltages and frequencies shown in FIG. 9A. For example, in FIG. 9C, for the amount of change in frequency in the range from 0 to 2.5 GHz, the attenuation levels AT change from −40 dB to about 0 dB.

Next the attenuation level AT (decibel value) is converted into a transmissivity T (between 0 and 1) through the following equation:

P=10^{(AT/10)}

Converting the attenuation level AT (a decibel value) into the transmissivity T produces the graph of FIG. 9D. It is possible to produce a graph showing the relationship between the amount of change in frequency and the transmissivity through performing such calculations and processes.

On the other hand, when this type of graph can be obtained, then a polynomial approximation is performed so as to smoothly join together the graph. If T is the transmissivity and f is the frequency, then a sixth-order equation, such as the polynomial:

T(f)=a₀+a₁f+a₂f²+a₃f³ . . . a₆f⁶ (1)

is used for the approximation. FIG. 9E is an example of a graph illustrating the curve approximating FIG. 9D. Here each of the coefficients a₀ through a₆ are constants that are calculated through the least-squares method, or the like. In this curve approximation there is no limitation to a six-order function, but rather it may be a curve of any given order of the second order or above. The equation obtained in this way can be applied also to a single controlled element group at any part in a LCOS.

(Calibrating the Variable Optical Filter Array Device)

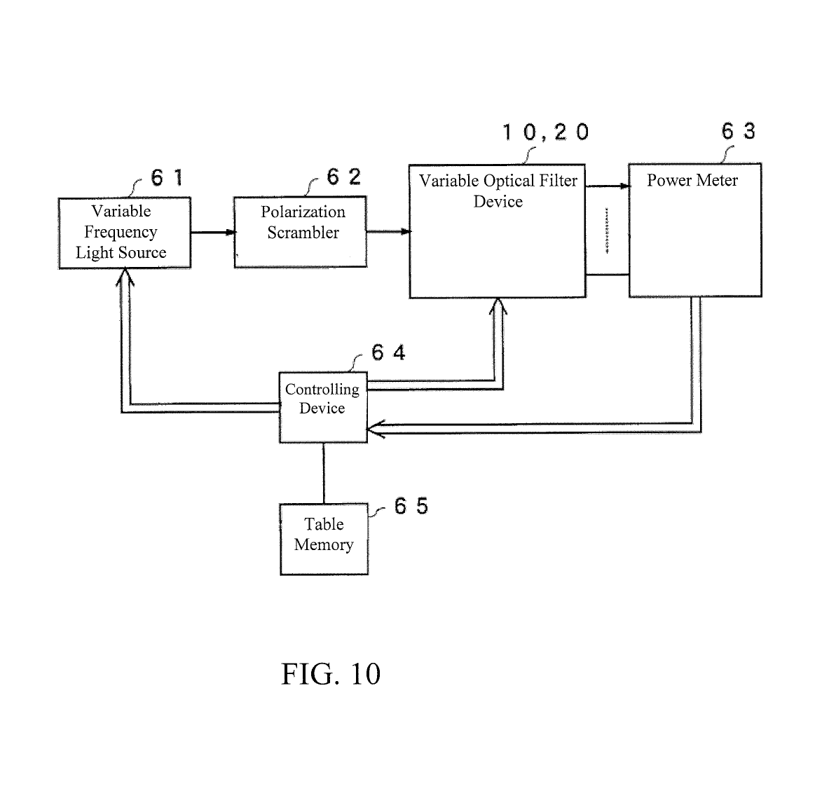

Because when the individual pixel groups are illuminated, the widths of the frequencies that can be controlled by the pixel groups are not all the same, it is necessary to perform calibration in advance. FIG. 10 is a block diagram illustrating a calibration system for determining the pixel positions and characteristics relative to frequencies in the frequency selecting element. In this diagram, a variable frequency light source 61 is a light source for performing frequency scanning, able to continuously vary and emit monochromatic light from a frequency of fₐ through a frequency of f_{b} for the frequency band used in the variable optical filter device. In the present faun of embodiment, the frequencies are scanned at a constant speed, based on a signal from the outside, to emit a frequency scanning beam. The output from the variable frequency light source 61 passes through a polarization scrambler 62, to be outputted as an incident beam into the variable optical filter device 10 and 20, described above. Given this, the emitted light from the variable optical filter device 10 or 20 is inputted into the power meter 63. The power meter 63 detects the power for each individual channel and outputs the power level data to a controlling device 64. The controlling device 64 calculates the correspondence between the pixel and the frequency as well as the output characteristics, based on the frequency outputted by the variable frequency light source 61, the pixel set so as to output the input light in the variable optical filter device, and the output level detected by the power meter 63, and stores the result thereof into a table memory 65.

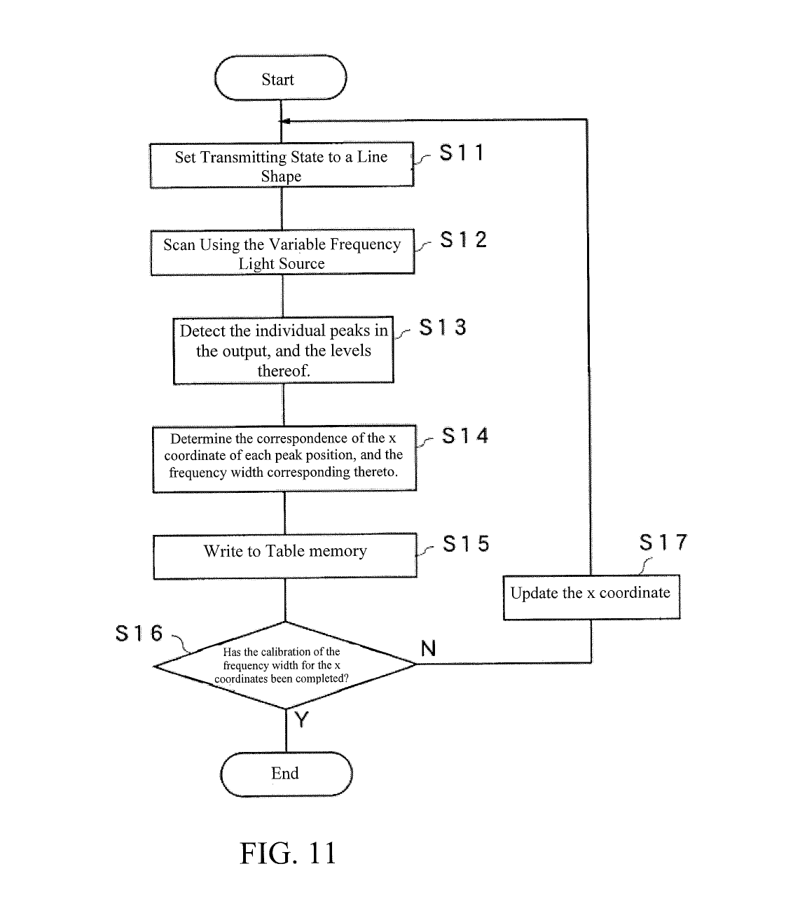

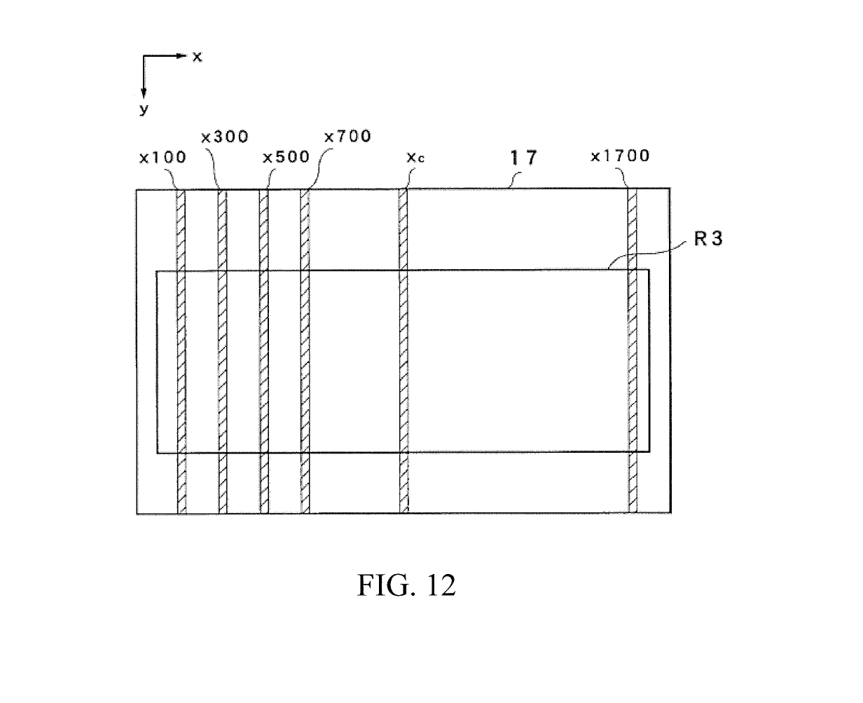

The details of the method for calibration in order to determine the frequencies displayed by the x coordinates of the individual pixels will be described in detail below. As illustrated in FIG. 3A and FIG. 3B, the x axial direction is the direction of frequency dispersion, but it is necessary to determine the frequency width corresponding to each pixel in the direction of the dispersion of frequency on the frequency selecting elements 17 and 25. In the present form of embodiment, the process to do so is performed based on the flow chart illustrated in FIG. 11. Note that in the variable optical filter device 10, below, the calibration is performed for an LCOS element 17A1 wherein there is intensity modulation. The coordinates of the individual pixels in the LCOS element 17A1 illustrated in FIG. 12 are from (x1, y1) through (x1920, y1000). First the control device 64, in Step S11, places into a reflective state pixels in a plurality of lines, indicated by the hatching, such as, for example, pixels in a line that is parallel to the y axis such as, for example, all pixels wherein the x coordinate is, for example, x100, or pixels in the line that is parallel to the y axis that is all of the pixels wherein the x coordinate is x300. Doing so causes the light that is incident on the pixels at those locations to be returned to the output side, and thus reduces the insertion loss as a reflective variable optical filter device 10. Here, in order to determine the x-coordinate easily, the reflectivity is reduced for a portion of these lines, for example, for the x-coordinate x_{c} in the center, is set to be smaller than for the others.

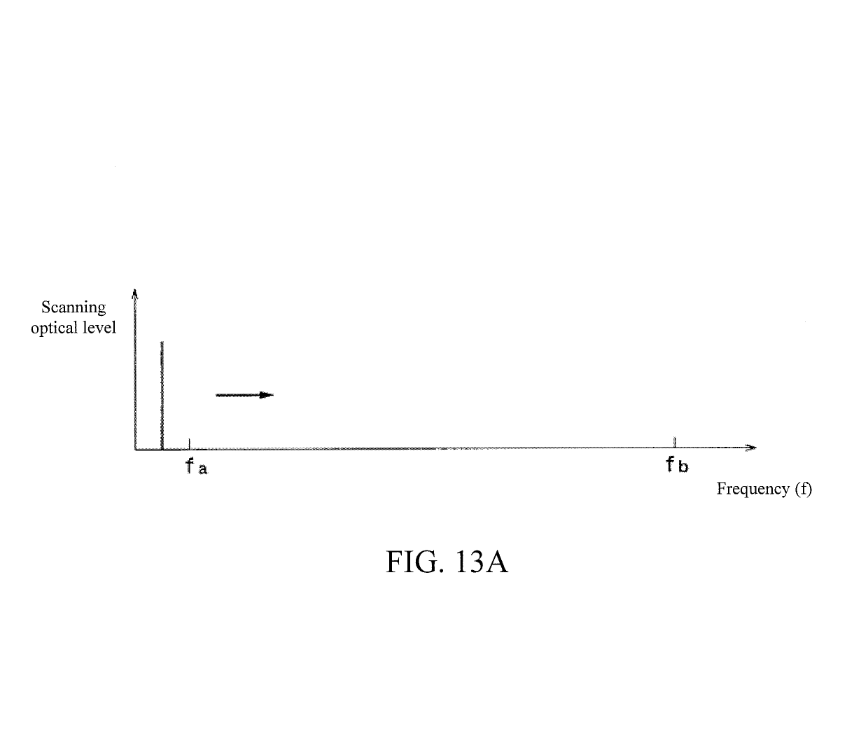

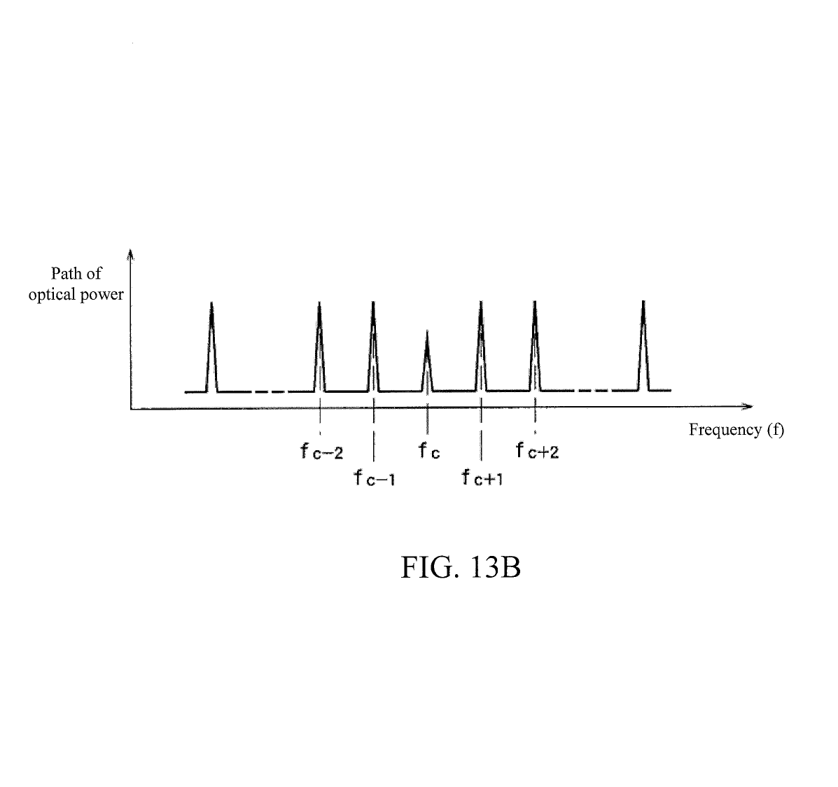

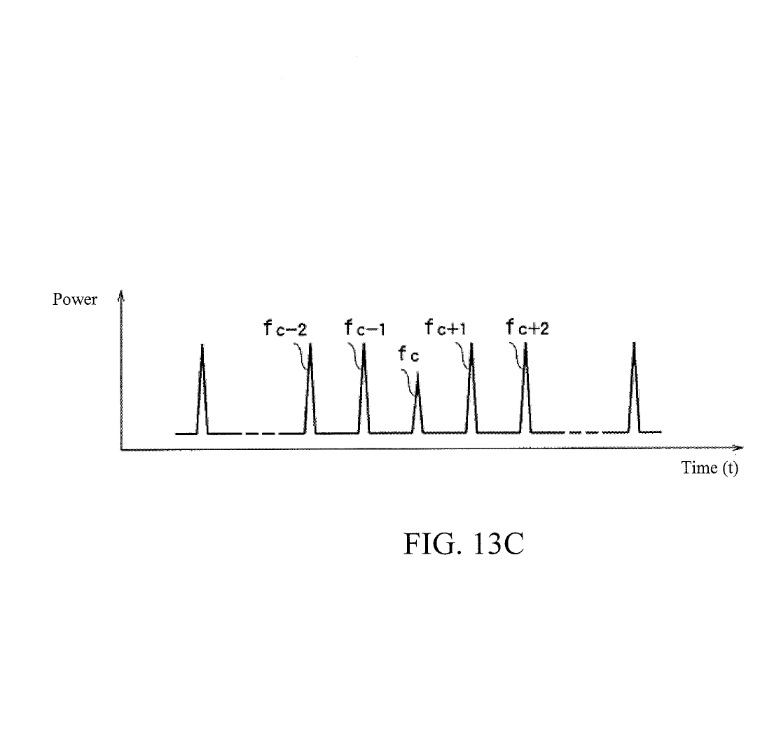

In Step S12, a beam that is frequency scanned in the range of the frequency band that is to be used, as illustrated in FIG. 13A, is outputted from the variable frequency light source 61. Doing so inputs the frequency scanning beam from the optical fiber 11 of the variable optical filter device 10 through the polarization scrambler 62. As illustrated in FIG. 13A, when the frequency-scanned beam is incident from the optical fiber, the beam is scanned on the LCOS element 17A1, depending on the frequency, through the frequency dispersing element 15. The input region R3 in FIG. 12 shows the track of the beam during a single scan. Doing so makes it possible to obtain an output on the optical fiber 14 side through reflecting the beam that is incident onto the elements that are in the reflective state. FIG. 13B shows the track of this output. Given this, the power from the optical fiber 14 is detected by the power meter 63.

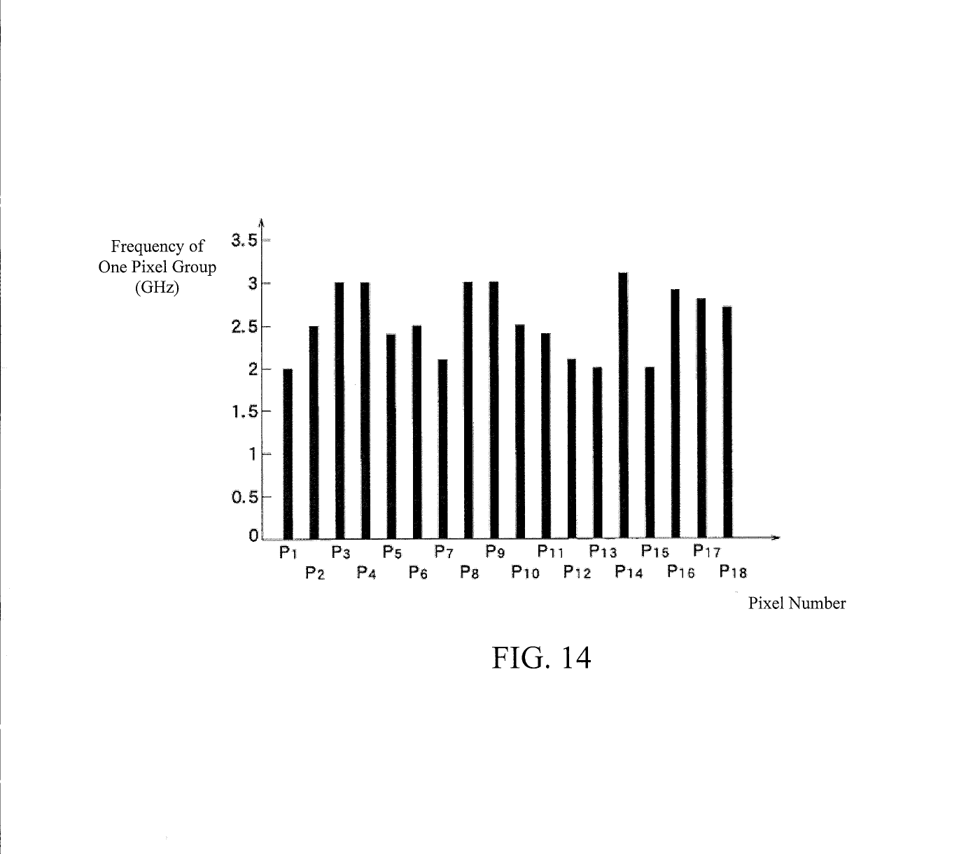

Following this, in Step S13, the peak of the output, and level thereof, is detected by the power meter 63, and, in Step S14, the correspondence relationship between the frequency and pixels is determined from the relationship between the detected power peak and frequency. For example, as illustrated in FIG. 13 B and FIG. 13C, the frequency f_{c} of the peak output at the center, wherein the level is low when compared to the others, can be considered to be the reflected light from the center line wherein the reflectivity is lower than the others. Consequently, the coordinate of x_{c} corresponds to the frequency f_{c}. Given this, the range until a specific amount of attenuation (for example, −3 dB) from the peak value for the frequency f_{c} is defined as the frequency range received by the pixel group at this x coordinate. Similarly, the frequencies corresponding to the lines that are in the reflective states, and the frequency ranges of those pixel groups, are all established sequentially as the x coordinates that are in the state that reflect the frequencies f_{c-1}, f_{c+1} that are the peaks that are therebefore and thereafter, and then the coordinates x for the state that reflects the frequencies f_{c-2}, f_{c+2} that are before and after those, and so forth. In Step S15, the frequencies corresponding to the x coordinates thus obtained are written by the controlling device 64 to the table memory 65. Given this, in Step S16, there is a control for whether or not calibration has been completed for the frequency range corresponding to the x coordinates that are in the normal state, and if not completed, then, in Step S17, the x-coordinate is updated and the same process is repeated. Doing so makes it possible to establish the relationships between the x coordinates of the pixels in the LCOS element 17A1 and the frequency ranges thereof FIG. 14 is a graph showing the relationships between the pixel numbers and the frequency widths, obtained in this manner

The function illustrated in Equation (1), above, can be applied also to, for example, a single controlled pixel group at any part of the LCOS. That is, the value of Equation (1) that is obtained through weighting with the frequencies for the individual pixels, which have actually already been set, can be used at any location, even if the width of the individual pixel group changes as illustrated in FIG. 14, for a controlled pixel group. For example, in FIG. 14 the frequency width is 2.5 GHz for the pixel groups P₂ and P₁₀, 2 GHz for the pixel group P₁₃, and 3 GHz for the pixel group P₈. That is, f₂ and f₁₀ are 0 through 2.5 GHz, f₁₃ is 0 through 2 GHz, and f₈ is 0 through 3 GHz. In FIG. 9A through FIG. 9E, when the function in Equation (1) is obtained from pixel number P₂, the use of the frequency f₁₃, wherein the pixel group P₁₃, for example, is normalized using the equation:

f₁₃=2.0/2.5×f₂

enables the application of the function in Equation (1), described above.

Similarly, for the pixel group P₈ that has the frequency range of 3.0 GHz, the use of the frequency f₈ that is normalized using the equation:

f₈=3.0/2.5×f₂

enables application of the function in Equation (1), above.

(Central Frequency Shift)

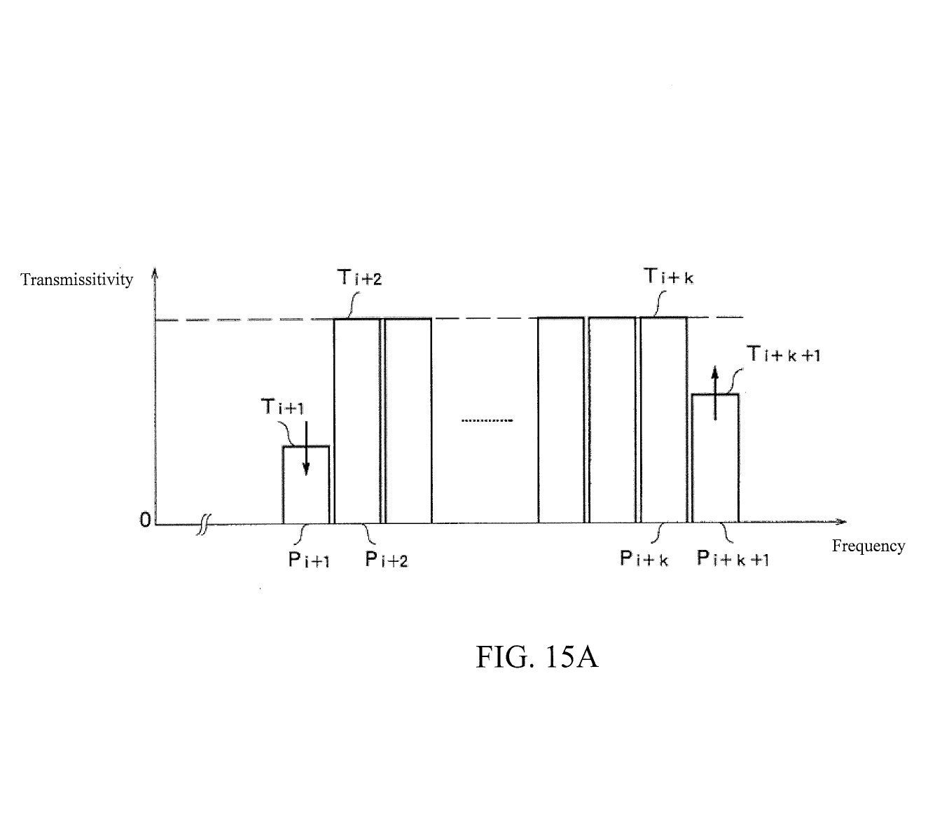

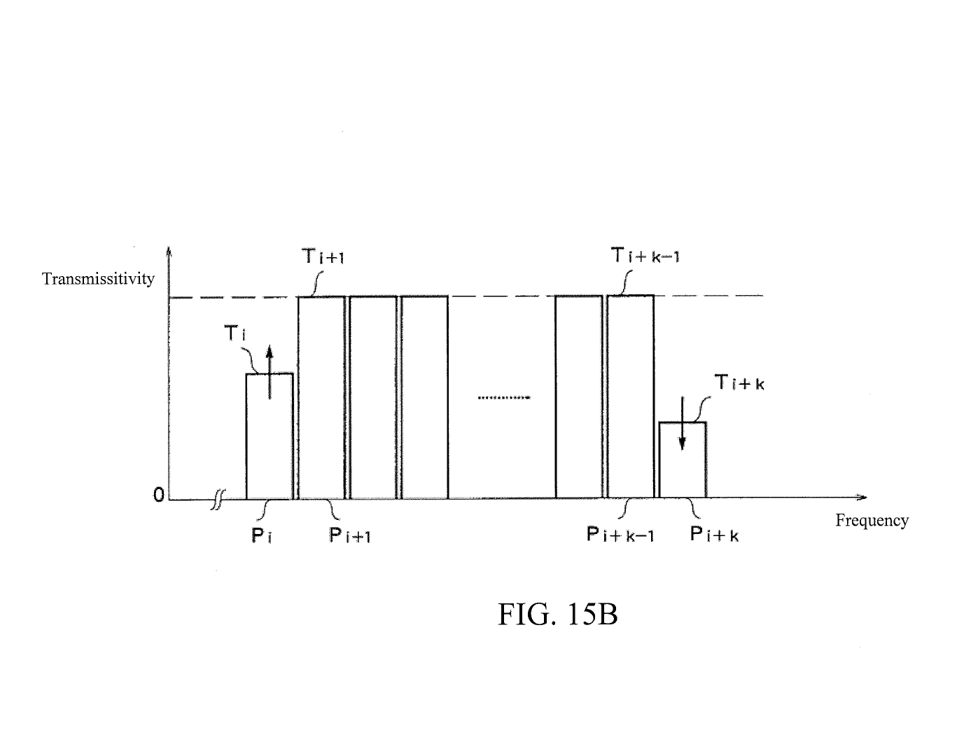

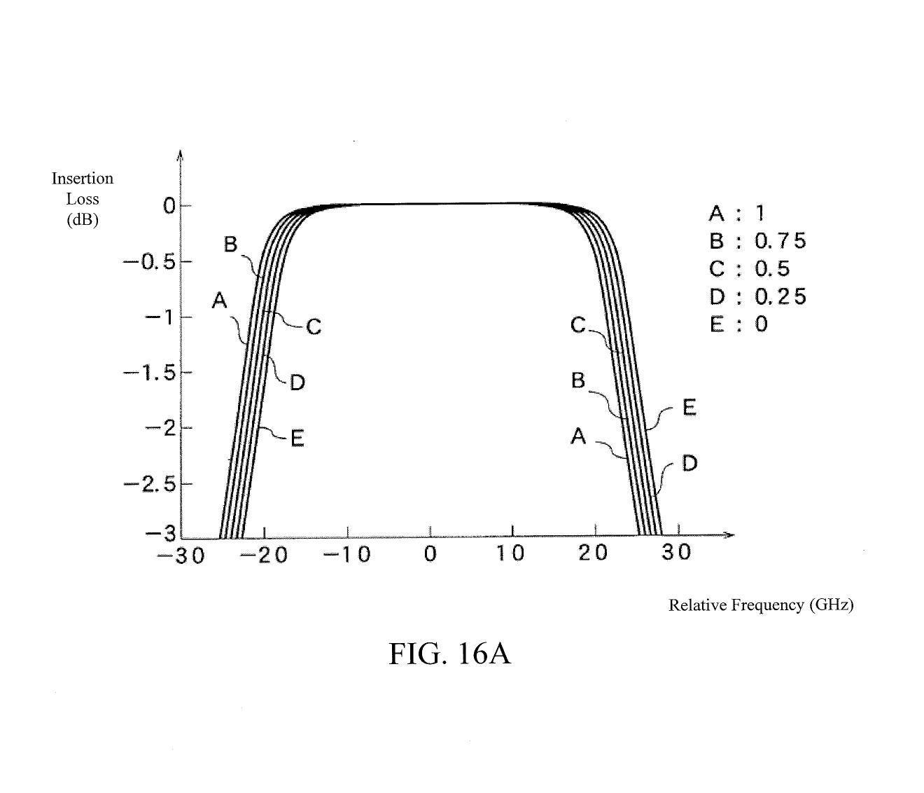

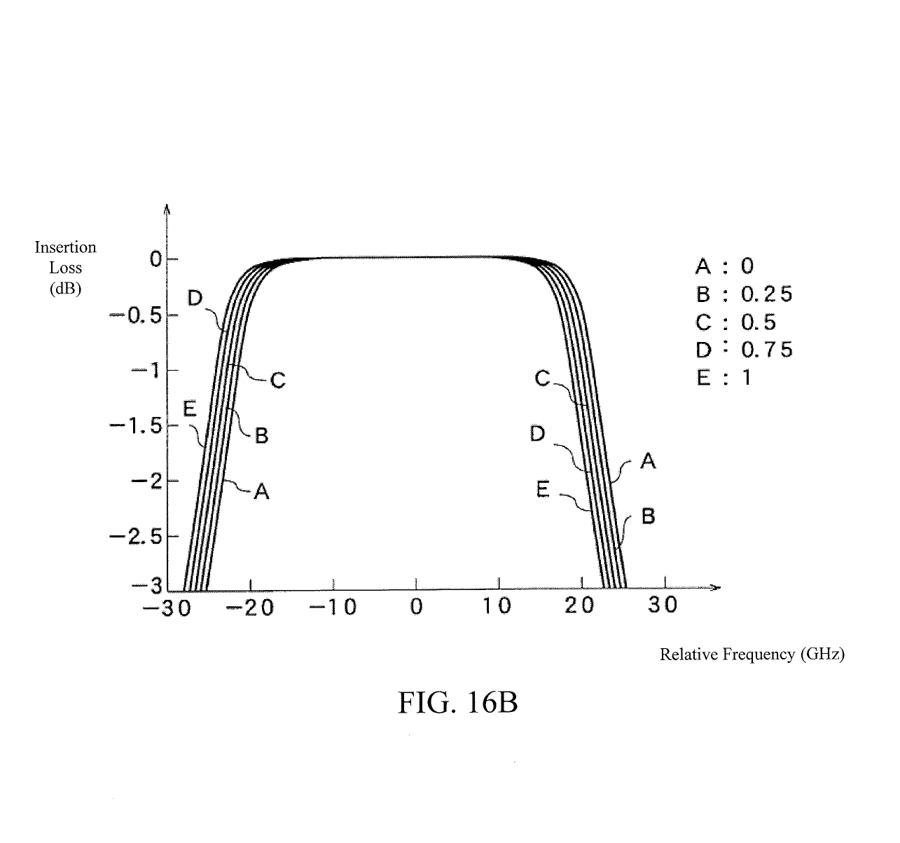

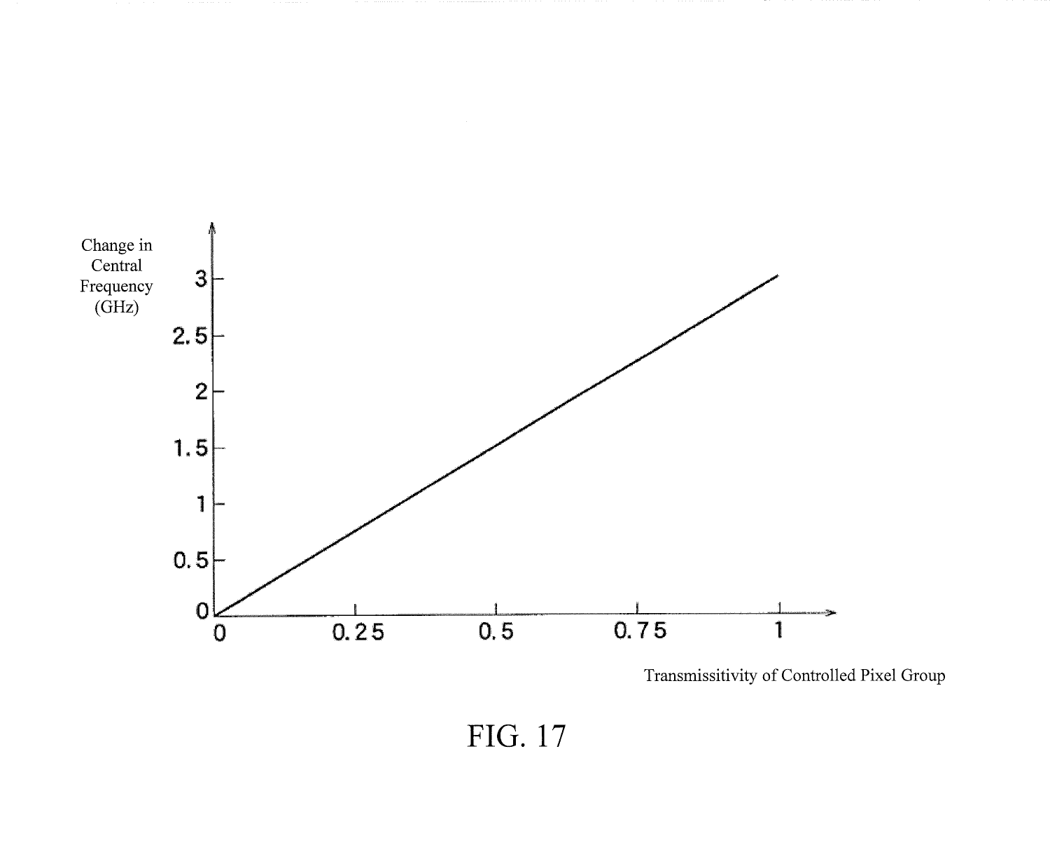

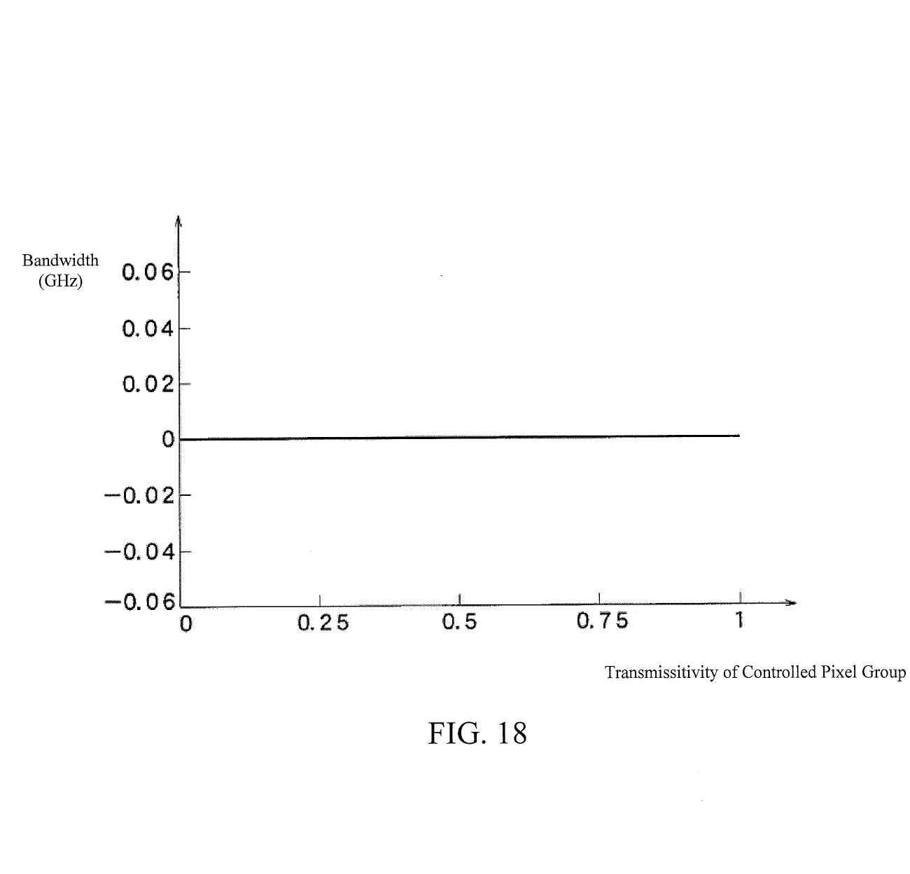

A controlling method for shifting the central frequency of a band pass filter according to a second form of embodiment will be explained next. First it is assumed that a band pass filter is structured wherein the transmissivities Tᵢ₊₁ through Tᵢ₊ₖ are 1 for the pixel groups Pᵢ₊₁ through Pᵢ₊ₖ, and 0 for the others, where a range of optical frequencies is caused to be incident on the pixel groups Pᵢ₊₁ through Pᵢ₊ₖ. Here, if shifting the pass band to the high-frequency side, then, as illustrated in FIG. 15, the transmissivity of the pixel group Pᵢ₊ₖ₊₁ (a first controlled pixel group) that is adjacent to the pixel group Pᵢ₊ₖ of the highest frequency is gradually increased, and the transmissivity of the pixel group Pᵢ₊₁ (a second controlled pixel group) of the lowest frequency is gradually decreased. At this time, the transmissivities of the controlled pixel groups Pᵢ₊₁ and Pᵢ₊ₖ₊₁ are changed continuously so as to total 1. When curves A through E are defined as for the times wherein the transmissivities Tᵢ₊₁ of the controlled pixel groups Pᵢ₊₁ are reduced by units of 0.25 from 1 to 0, then, as illustrated in FIG. 16A and FIG. 17, the central frequency of the band pass filter can be increased continuously. At this time, having the totals of the amounts of change in transmissivity of the controlled pixel groups be zero means that there is no change in band width, as illustrated in FIG. 18.

The method for controlling to reduce the central frequency of the filter from the initial state, described above, will be explained below. In this case, control is performed so as to increase continuously the transmissivity Tᵢ of the pixel group Pᵢ that is adjacent to the pixel group Pᵢ₊₁ (the first controlled pixel group) on the low-frequency side, in this direction of change, and to decrease continuously the transmissivity Tᵢ₊ₖ of the pixel group Pᵢ₊ₖ (the second controlled element group) on the high-frequency side. Here FIG. 15B shows the state of the change wherein the condition is maintained that the sum of the transmissivities of the controlled pixel groups Pᵢ and Pᵢ₊ₖ on both ends is to be maintained at 1. When curves A through E are defined as for the times wherein the transmissivities of the controlled pixel groups Pᵢ are increased units of 0.25 from 0 to 1, then, as illustrated in FIG. 16B, the central frequency of the band pass filter will be decreased corresponding to the change in the transmissivity of the controlled pixel group, but the filter and with will remain constant, making it possible to shift the frequency to the low-frequency side.

In either of the cases set forth above, if the width over which the central frequency can be changed is in excess of a frequency corresponding to one pixel, then it is possible to control, limitlessly and continuously, the width over which the central frequency can be changed by shifting the controlled pixel groups sequentially to adjacent pixel groups.

The optical design conditions over which these control methods are effective will be explained next. Because in the present form of embodiment the intermediate values for the transmissivities of the individual pixel groups are reflected in the filter waveform, the conditions wherein the characteristics can be changed continuously are determined in this way depending on the width of the individual pixels in the controlled pixel groups in the direction of frequency dispersion and the input beam radius. That is, if the width of the controlled pixel group is large when compared to the input beam radius of each of the frequency components of the WDM signal beam, then one may envision the transmissivities designed into the controlled pixel group being reflected as-is into the filter waveform and producing distortion. Here, in the frequency selecting element, the width of the element in the direction of frequency dispersion is defined as d, and the range of the optical intensity to 1/d² of the peak is defined as the beam radius w for each of the frequency components. At this time, a parameter γ, which is defined by the pixel width d and the beam radius w, is introduced:

γ=w/d

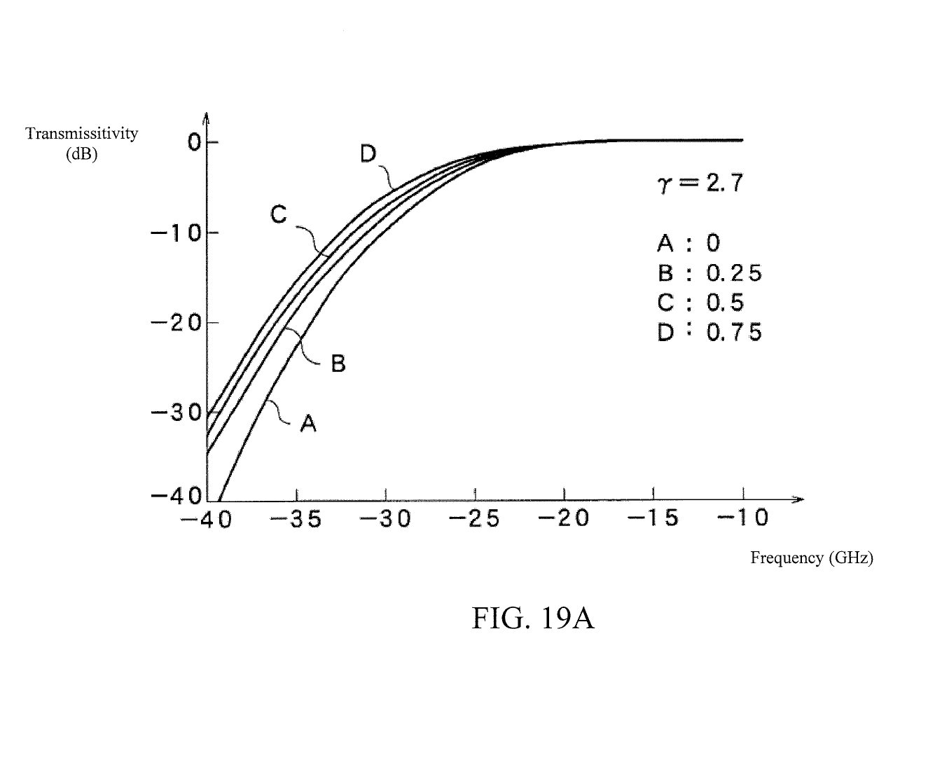

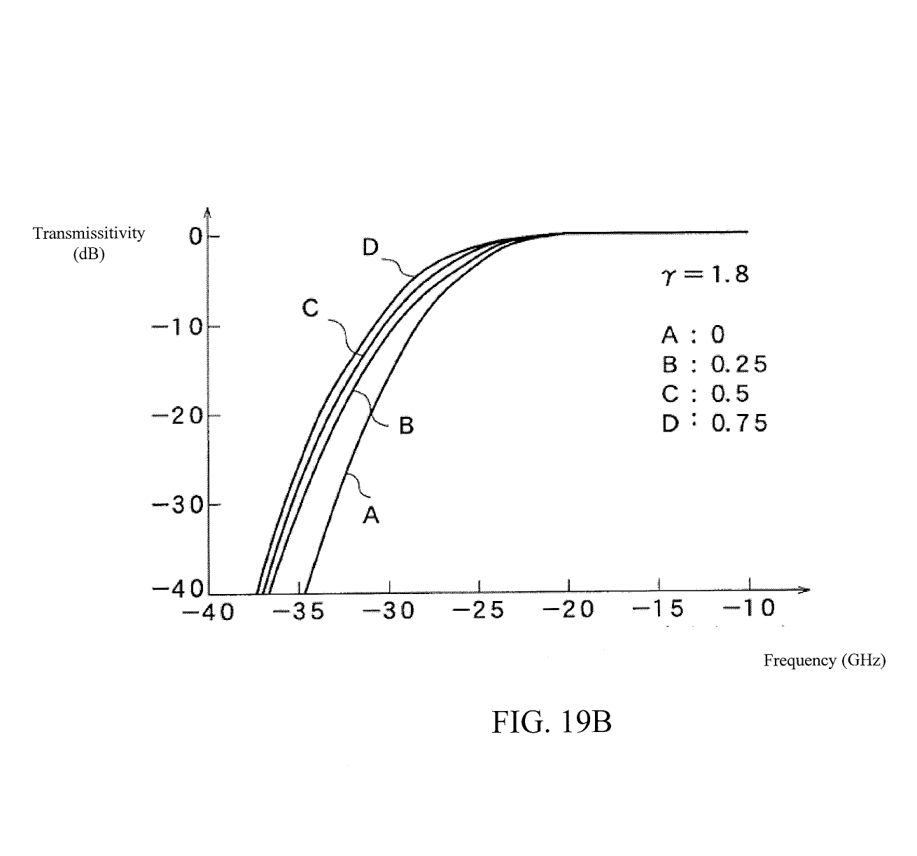

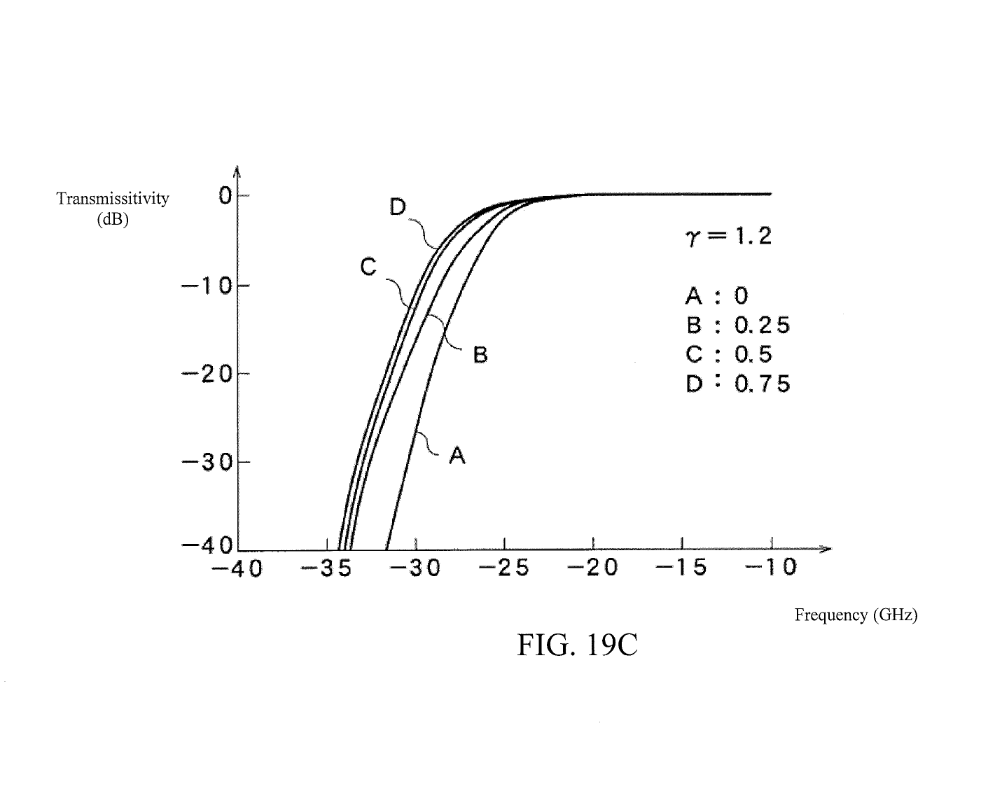

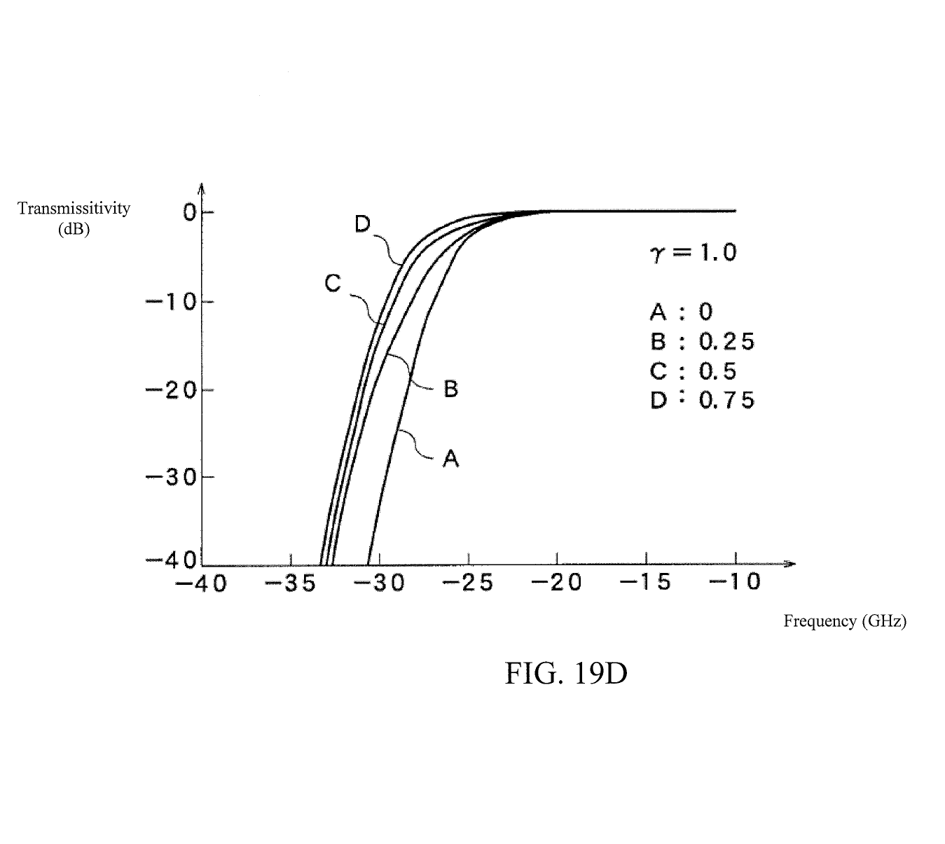

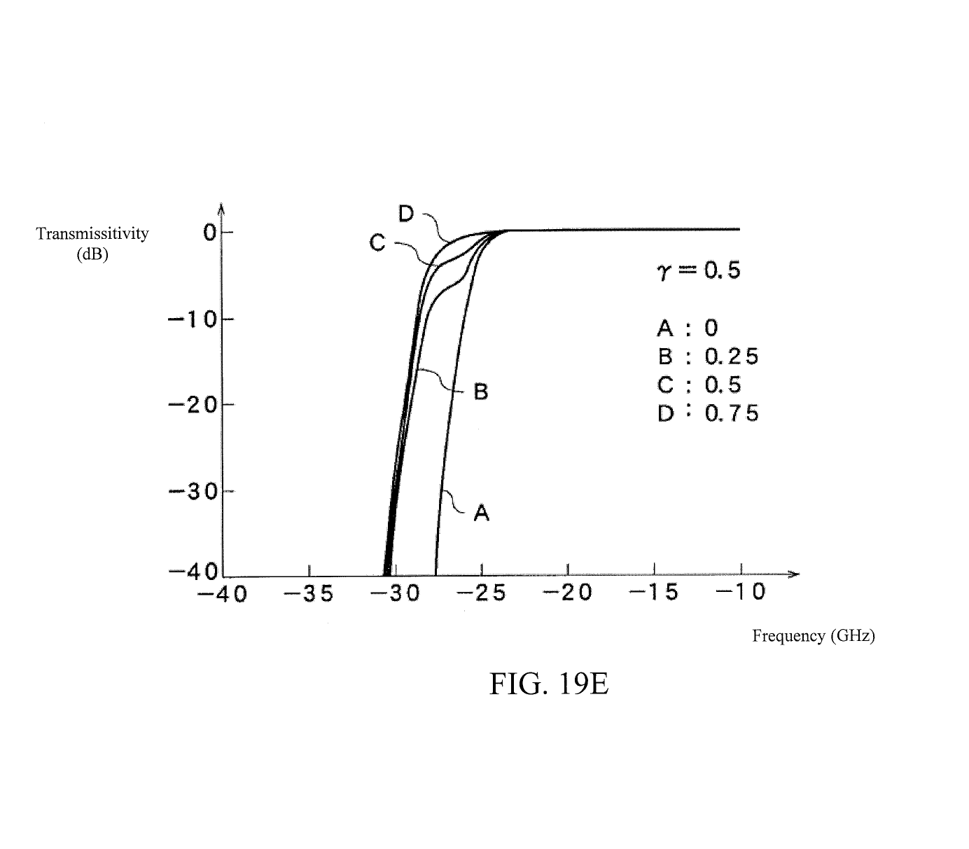

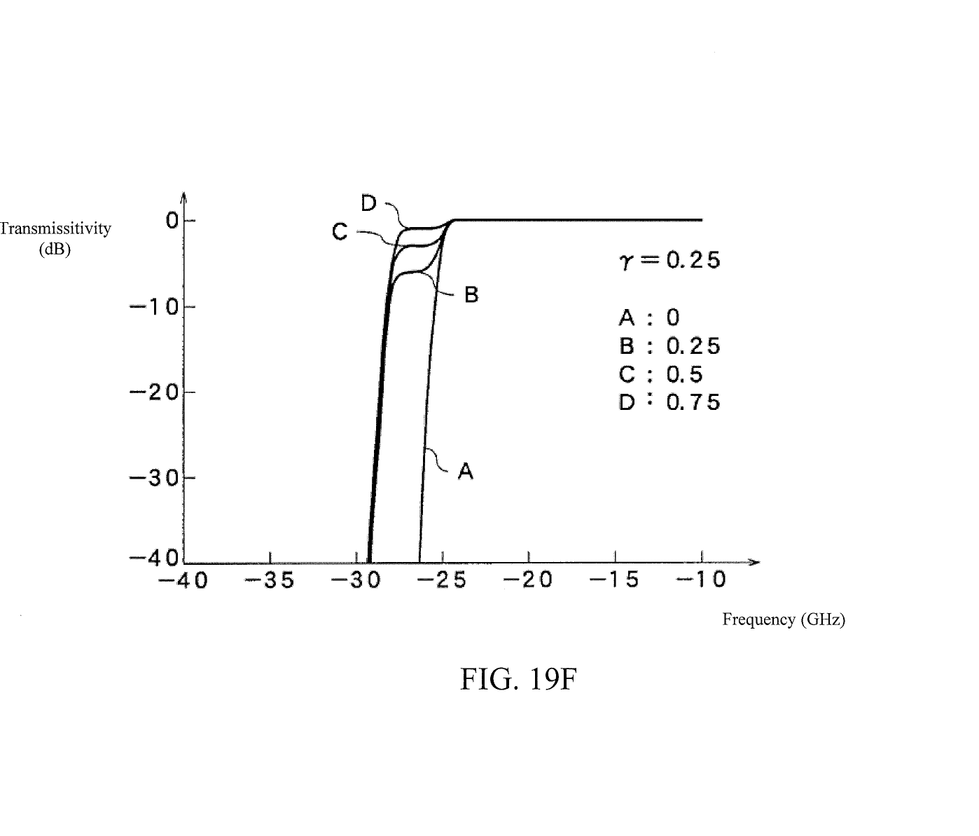

FIG. 19A through FIG. 19F show the relationships between the transmitted frequencies and the transmissivities when changing the transmissivities of the controlled pixel groups on the low-frequency side in units of 0.25 from 0 to 0.75 in order to be compatible with the band width under the conditions set forth above or in order to reduce the central frequency. In these figures, FIG. 19A is for the case of γ=2.7, FIG. 19B is for the case of γ=1.8, FIG. 19C is for the case of γ=1.2, FIG. 19D is for the case of γ=1.0, FIG. 19E is for the case of γ=0.5, and FIG. 19F is for the case of γ=0.25. As is understood from these figures, no distortion occurs in the waveform if γ is 1.0 or more, but if γ is less than 1, that is, if γ is 0.5 or 0.25, then the transmissivity response is reflected into the filter waveform, producing distortion. Because of this, preferably γ is at least 1, that is, the pixel width d is smaller then the input beam radius w.

While the variable optical filter device set forth above uses a WDM signal beam as the incident beam, the incident beam is not limited to being a WDM signal beam. That is, the present invention can be used in various different types of filtering of any given type of beam, for example, may be used in fields such as that of tunable lasers or spectroscopy.

Moreover, in this faun of embodiment the functional equation shown in Equation (1) was stored in advance and the frequency selecting element was driven based on that functional equation; however, instead a table indicating the relationships between the transmissivities and the amounts of variation in frequency may be stored in memory in a table in advance, and the frequency selecting element may be driven based thereon. In this case, the table may store data for each specific frequency step, and the voltage levels for the frequency selecting element may be controlled using spline-interpolated values therebetween, and the spline-interpolated values themselves may be stored as a table.

Moreover, while in the form of embodiment set forth above the explanation was for changes through intensity modulation of the driving voltages for the frequency selecting element, in the case of producing a diffraction phenomenon through a pattern in the refractive indices and controlling the reflectivities or transmissivities, the same processes may be performed as when performing intensity modulation through varying the peak values while maintaining a uniform voltage periodicity in a comb-shaped waveform that is applied to the individual pixels.

### [Potential for Use in Industry]

The present invention, as explained in detail above, enables changes in the frequency selecting characteristics for the incident beam through changing the reflection characteristics or transmission characteristics of the frequency selecting element by the pixel unit. This enables use as the primary structural element, having a node RODAM function that has a WDM beam add/drop function, or as a structural element in a spectroscopic device.

### EXPLANATION OF CODES

11, 14, 21, 29: Optical Fibers

12, 13, 22, 28: Collimating Lenses

16, 24, 26: Lenses

15, 23: Frequency Dispersing Elements

17, 25: Frequency Selecting Elements

17A1, 25A1: Two-Dimensional LCOS Elements

17A1, 25A2: Two-Dimensional Electrode Array Liquid Crystal Elements

17A3: Two-Dimensional MEMS Element

17B1, 25B1: One-Dimensional LCOS Element

17B1, 25B2: One-Dimensional Electrode Array Liquid Crystal Element

17B3: One-Dimensional MEMS Element

27: Frequency Combining Element

30, 32: Setting Portions

31, 33: Drivers

41, 51, 53: Transparent Electrodes

42, 52: Liquid Crystal

43: Reflective Electrode

44, 454, 55: Polarizer

1. A method for controlling a characteristic of a variable optical filter including a large number of pixels arranged in a direction of frequency dispersion for inputting light that has been dispersed spatially depending on frequencies, and including a frequency selecting element having a desired frequency selecting characteristic through changing characteristics of individual pixels, the method comprising:
changing a driving voltage for a specific pixel of the frequency selecting element continuously to produce an amount of change in a frequency that is passed through that pixel;
changing a driving voltage value for a specific pixel of the frequency selecting element continuously to produce an attenuation value for a beam that is passed through that pixel;
calculating, from a relationship between the driving voltage and a frequency characteristic and between the driving voltage and amount of attenuation, a function that indicates an approximated curve of no less than a second order and no more than a sixth order for expressing a relationship between a transmissivity and a frequency; and
controlling the characteristic through driving a controlled pixel of the frequency selecting element based on the function.

2. The method for controlling a characteristic of a variable optical filter device as set forth in claim 1, wherein:
the variable optical filter device comprises:
an incident/emitting portion for inputting a beam and emitting a beam of an incident beam with a selected frequency;
a frequency dispersing element for dispersing spatially, depending on a frequency thereof, a beam that is incident into the incident/emitting portion and for combining reflected beams;
a beam condensing element for condensing, so as to be parallel to a two-dimensional surface, beams that have been dispersed by the frequency dispersing element;
a frequency selecting element for producing a desired frequency selecting characteristic through changing a reflectance characteristic of an individual pixels, having a large number of pixels that are arranged in at least the frequency dispersing direction, arranged at locations for receiving beams that are focused by the beam condensing element; and
a frequency selecting element driving portion for driving, in gradations, transmission characteristics for each frequency of the incident beam through driving electrodes of the individual pixels of the frequency selecting element.

3. The method for controlling a characteristic of a variable optical filter device as set forth in claim 1, wherein:
the variable optical filter device comprises:
an incident portion wherein a beam is incident;
a frequency dispersing element for dispersing spatially, depending on a frequency thereof, a beam that is incident into the incident portion and for combining reflected beams;
a first beam condensing element for condensing, so as to be parallel on a two-dimensional surface, beams that have been dispersed by the frequency dispersing element;
a frequency selecting element for selecting a beam of an arbitrary frequency selecting characteristic through changing a transmissive characteristic of an individual pixels, having a large number of pixels that are arranged in at least the frequency dispersing direction, arranged at locations for receiving beams that are focused by the first beam condensing element;
a frequency selecting element driving portion for driving, in gradations, transmission characteristics for each frequency of the incident beam through driving electrodes of the individual pixels of the frequency selecting element;
a second beam condensing element for condensing beams that have passed through the frequency selecting amendment element;
a frequency combining element for combining dispersed beams that have been condensed by the second beam condensing element; and
an emitting portion for emitting a beam that has been combined by the frequency combining element.

4. The method for controlling a characteristic of a variable optical filter device as set forth in claim 1, further comprising:
controlling the frequency selecting element by storing into memory a table indicating a relationship between transmissivities and amounts of frequency variation indicated by the function that has been calculated, and setting, to the frequency selecting element, driving voltages that correspond to the amounts of frequency variation of the transmissivity that is required, read out from the table, to control the frequency selecting element.

5. The method for controlling a characteristic of a variable optical filter device as set forth in claim 1, further comprising:
controlling the frequency selecting element by storing into memory a table indicating a relationship between transmissivities and amounts of frequency variation indicated by the function that has been calculated, and setting, to the frequency selecting element, driving voltages that are calculated through spline interpolation from the amounts of frequency variation of the transmissivity that are required, read out from the table, to control the frequency selecting element.

6. The method for controlling a characteristic of a variable optical filter device as set forth in claim 2, wherein:
in the frequency selecting element, pixel width in the direction of frequency dispersion is less than a beam radius, in the direction of frequency dispersion, of the incident beam.

7. The method for controlling a characteristic of a variable optical filter device as set forth in claim 2, wherein:
the frequency selecting element is a LCOS element that has a large number of pixels that are arranged in at least one dimension; and the frequency selecting element driving portion controls a voltage applied to an individual pixel in accordance with a frequency selecting characteristic.

8. The method for controlling a characteristic of a variable optical filter device as set forth in claim 2, wherein:
the frequency selecting element is a liquid crystal element that has a large number of pixels that are arranged in at least one dimension; and
the frequency selecting element driving portion controls a voltage applied to an individual pixel in accordance with a frequency selecting characteristic.

9. The method for controlling a characteristic of a variable optical filter device as set forth in claim 2, wherein:
the frequency selecting element is a MEMS element that has a large number of pixels that are arranged in at least one dimension; and
the frequency selecting element driving portion controls a voltage applied to an individual pixel in accordance with a frequency selecting characteristic.

10. The method for controlling a filter characteristic of a variable optical filter device as set forth in claim 2, further comprising:
for individual frequencies of the incident beam, placing a desired continuous pixel group in a transmissive state when a transmissivity of a pixel group is defined as a ratio of incident/emitted beam emitted through the pixel group, the pixel group comprising at least one pixel of the frequency selecting element corresponding to an individual frequency; and
increasing band width through gradually increasing, simultaneously, the transmissivities of at least one first controlled pixel group that is adjacent to a pixel group of an end portion of pixel groups in a transmitted frequency range and of at least one second controlled pixel group that is adjacent to a pixel group at the other end portion of that transmitted frequency band.

11. The method for controlling a filter characteristic of a variable optical filter device as set forth in claim 2, further comprising:
for individual frequencies of the incident beam, placing a desired continuous pixel group in a transmissive state when a transmissivity of that pixel group is defined as a ratio of incident/emitted beam emitted through the pixel group, the pixel group comprising at least one pixel of the frequency selecting element corresponding to an individual frequency; and
decreasing band width through gradually decreasing, simultaneously, the transmissivities of at least one first controlled pixel group of an end portion of pixel groups in a transmitted frequency range and of at least one second controlled pixel group of the other end portion of that transmitted frequency band.

12. The method for controlling a filter characteristic of a variable optical filter device as set forth in claim 2, further comprising:
for individual frequencies of the incident beam, placing a desired continuous pixel group in a transmissive state when a transmissivity of that pixel group is defined as a ratio of incident/emitted beam emitted through the pixel group, the pixel group comprising at least one pixel of the frequency selecting element corresponding to an individual frequency; and
changing a central frequency of a transmission frequency band along a frequency axis through gradually increasing an optical transmissivity of at least one first controlled pixel group adjacent to a pixel group at an end portion, in the direction of the change of frequency, of the pixel groups of the transmitted frequency band and gradually decreasing an optical transmissivity of at least one second controlled pixel group at the other end portion of the pixel groups of the transmitted frequency band.

13. The method for controlling a characteristic of a variable optical filter device as set forth in claim 3, wherein:
in the frequency selecting element, pixel width in the direction of frequency dispersion is less than a beam radius, in the direction of frequency dispersion, of the incident beam.

14. The method for controlling a characteristic of a variable optical filter device as set forth in claim 3, wherein:
the frequency selecting element is a LCOS element that has a large number of pixels that are arranged in at least one dimension; and
the frequency selecting element driving portion controls a voltage applied to an individual pixel in accordance with a frequency selecting characteristic.

15. The method for controlling a characteristic of a variable optical filter device as set forth in claim 3, wherein:
the frequency selecting element is a liquid crystal element that has a large number of pixels that are arranged in at least one dimension; and
the frequency selecting element driving portion controls a voltage applied to an individual pixel in accordance with a frequency selecting characteristic.

16. The method for controlling a filter characteristic of a variable optical filter device as set forth in claim 3, further comprising:
for individual frequencies of the incident beam, placing a desired continuous pixel group in a transmissive state when a transmissivity of a pixel group is defined as a ratio of incident/emitted beam emitted through the pixel group, the pixel group comprising at least one pixel of the frequency selecting element corresponding to an individual frequency; and
increasing band width through gradually increasing, simultaneously, the transmissivities of at least one first controlled pixel group that is adjacent to a pixel group of an end portion of pixel groups in a transmitted frequency range and of at least one second controlled pixel group that is adjacent to a pixel group at the other end portion of that transmitted frequency band.

17. The method for controlling a filter characteristic of a variable optical filter device as set forth in claim 3, further comprising:
for individual frequencies of the incident beam, a desired continuous pixel group in a transmissive state when a transmissivity of that pixel group is defined as a ratio of incident/emitted beam emitted through the pixel group, the pixel group comprising at least one pixel of the frequency selecting element corresponding to an individual frequency; and
decreasing band width through gradually decreasing, simultaneously, the transmissivities of at least one first controlled pixel group of an end portion of pixel groups in a transmitted frequency range and of at least one second controlled pixel group of the other end portion of that transmitted frequency band.

18. The method for controlling a filter characteristic of a variable optical filter device as set forth in claim 3, further comprising:
for individual frequencies of the incident beam, placing a desired continuous pixel group in a transmissive state when a transmissivity of that pixel group is defined as a ratio of incident/emitted beam emitted through the pixel group, the pixel group comprising at least one pixel of the frequency selecting element corresponding to an individual frequency; and
changing a central frequency of a transmission frequency band along a frequency axis through gradually increasing an optical transmissivity of at least one first controlled pixel group adjacent to a pixel group at an end portion, in the direction of the change of frequency, of the pixel groups of the transmitted frequency band and gradually decreasing an optical transmissivity of at least one second controlled pixel group at the other end portion of the pixel groups of the transmitted frequency band.

19. A method for controlling a characteristic of a variable optical filter including a frequency selecting element, the method comprising:
changing a driving voltage for a specific pixel of the frequency selecting element continuously to produce an amount of change in a frequency that is passed through that pixel;
changing a driving voltage value for a specific pixel of the frequency selecting element continuously to produce an attenuation value for a beam that is passed through that pixel;
calculating, from a relationship between the driving voltage and a frequency characteristic and between the driving voltage and amount of attenuation, a function that indicates an approximated curve of no less than a second order and no more than a sixth order for expressing a relationship between a transmissivity and a frequency; and
controlling the characteristic through driving a controlled pixel of the frequency selecting element based on the function.
